(19) United States
(12) Patent Application Publication
(10) Pub. No.: US 2004/0073468 A1
(43) Pub. Date: Apr. 15, 2004

(54) System and method of managing a fleet of machines

(75) Inventors: Bhavin J. Vyas, Peoria, IL (US); Timothy J. Funk, Peoria, IL (US)

Correspondence Address: James R. Yee, Patent Office, Howard & Howard Attorneys, P.C., 39400 Woodward Avenue, Suite 101, Bloomfield Hills, MI, 48304, US

(73) Assignee: CATERPILLAR INC.

(21) Appl. No.: 10/268,530

(22) Filed: Oct. 10, 2002

(51) Int. Cl. G06F 17/60

(52) U.S. Cl. 705/8

(57) ABSTRACT

A fleet management system manages a plurality of machines. The fleet manager includes a communication conduit coupled to the machines for receiving status information related to the machines and a repository coupled to the communication conduit for receiving and storing the status information. The system also includes a fleet manager controller coupled to the repository for analyzing the status information.

### TECHNICAL FIELD

The present invention relates generally to monitoring a fleet of machines, and more particularly, to monitoring a fleet of machines in view of a product analysis.

### BACKGROUND

The management of a large number or fleet of machines, such as mobile machines is a time consuming and difficult task. Fleet management involves not only gathering data regarding the fleet, but also managing and interpreting the data, and machine maintenance. Understanding how and when to maintain a machine, i.e., perform preventative maintenance, and coordinating all of the activity surrounding or going into the maintenance of a single machine is difficult.

Presently, there exist some systems that are designed to provide maintenance for a single machine. These systems, for example, may receive some status information from a machine, analyze the health of the machine in light of the status and historical data, establish a maintenance recommendation, and convey the information back to a user.

However, these machines have several limitations which prevent them for being useful for a fleet of machines. For examples, these systems do not utilize status information for a given machine, or group of machines. In addition, these systems are not capable of establishing or conveying fleet information to a fleet manager.

The present invention is aimed at one or more of the problems set forth above.

### SUMMARY OF THE INVENTION

In a first aspect of the present invention, a fleet management system for managing a plurality of machines is provided. The fleet manager includes a communication conduit coupled to the machines for receiving status information related to the machines and a repository coupled to the communication conduit for receiving and storing the status information. The system also includes a fleet manager controller coupled to the repository for analyzing the status information and responsively determining a product maintenance recommendation.

In a second aspect of the present invention, a fleet management system for managing a plurality of machines is provided. The system includes a communication conduit coupled to the machines for receiving status information related to the machines and a repository coupled to the communication conduit for receiving and storing the status information. The system also includes a fleet manager controller coupled to the repository for analyzing the status information and responsively modify the product maintenance schedule.

In a third aspect of the present invention, a fleet management system for managing a plurality of machines is provided. The system includes a communication conduit coupled to the machines for receiving status information related to the machines and a repository coupled to the communication conduit for receiving and storing the status information. The system also includes a fleet manager controller analyzing the status information and tracking at least one event for the plurality of machines,.

In a fourth aspect of the present invention, a computer program product for managing a plurality of machines, is provided. The computer program product includes computer readable program code means for receiving status information related to the machines and computer readable program code means for receiving and storing the status information in a repository. The computer program product also includes computer readable program code means for analyzing the status information and responsively determining a product maintenance recommendation.

In a fifth aspect of the present invention, a computer program product for managing a plurality of machines is provided. The computer program product includes computer readable program code means for receiving status information related to the machines and computer readable program code means for receiving and storing the status information in a repository. The computer program product also includes computer readable program code means for analyzing the status information and responsively modifying the product maintenance schedule.

In a sixth aspect of the present invention, a computer program product for managing a plurality of machines is provided. The computer program product includes computer readable program code means for receiving status information related to the machines and computer readable program code means for receiving and storing the status information in a repository, The computer program product also includes computer readable program code means for analyzing the status information and tracking at least one event for the plurality of machines.

In a seventh aspect of the present invention, a method for managing a plurality of machines provided. The method includes the steps of establishing status information related to the machines and receiving and storing the status information at a repository. The method also includes the step of analyzing the status information and responsively determining a product maintenance recommendation.

In an eighth aspect of the present invention a method for managing a plurality of machines is provided. The method includes the steps of establishing status information related to the machines and receiving and storing the status information in a repository. The method also includes the step of analyzing the status information and responsively modifying a product maintenance schedule.

In a ninth aspect of the present invention, a method for managing a plurality of machines, is provided. The method includes the steps of establishing status information related to the machines and receiving and storing the status information in a repository. The method further includes the step of analyzing the status information and tracking at least one event for the plurality of machines.

### BRIEF DESCRIPTION OF THE DRAWINGS

FIG. 1 is a block diagram of a fleet management system, according to an embodiment of the present invention:

FIG. 2. is a block diagram of a fleet management system, according to another embodiment of the present invention,

FIG. 3 is a block diagram of an onboard information manager for use with the fleet management system;

FIG. 4 is a block diagram of a computer program product, according to an embodiment of the present invention;

FIG. 5 is a block diagram of a computer program product, according to another embodiment of the present invention;

FIG. 6 is a block diagram of a computer program product, according to an still another embodiment of the present invention;

FIG. 7 is a flow diagram of a method, according to an embodiment of the present invention;

FIG. 8 is a flow diagram of a method, according to another embodiment of the present invention;

FIG. 9 is a flow diagram of a method, according to an still another embodiment of the present invention;

FIG. 10 is a diagrammatical illustration of an introductory screen, according to an embodiment of the present invention;

FIG. 11 is a diagrammatical illustration of an event summary screen, according to an embodiment of the present invention;

FIG. 12 is a second diagrammatical illustration of the introductory screen of FIG. 11;

FIG. 13 is a third diagrammatical illustration of the introductory screen of FIG. 11;

FIG. 14 is a diagrammatic illustration of an event screen, according to an embodiment of the present invention;

FIG. 15 is a diagrammatic illustration of an SOS history screen, according to an embodiment of the present invention;

FIG. 16 is a diagrammatic illustration of an SOS sample details screen, according to an embodiment of the present invention;

FIG. 17 is a diagrammatic illustration of graph, according to an embodiment of the present invention;

FIG. 18 is a diagrammatic illustration of a details dialog, according to an embodiment of the present invention;

FIG. 19 is a diagrammatic illustration of a service meter, fuel and location screen, according to an embodiment of the present invention;

FIG. 20 is a diagrammatic illustration of an SMU history screen2000, according to an embodiment of the present invention;

FIG. 21 is a diagrammatic illustration of a fuel history screen, according to an embodiment of the present invention;

FIG. 22 is a diagrammatic illustration of a location history screen, according to an embodiment of the present invention;

FIG. 23 is a diagrammatic illustration of a product watch screen, according to an embodiment of the present invention;

FIG. 24 is a second diagrammatic illustration of the product watch screen of FIG. 23;

FIG. 25 is a diagrammatic illustration of a product watch alarm screen, according to an embodiment of the present invention;

FIG. 26 is a diagrammatic illustration of a product watch details screen, according to an embodiment of the present invention;

FIG. 27 is a diagrammatic illustration of a preventative maintenance screen, according to an embodiment of the present invention;

FIG. 28 is a diagrammatic illustration of a preventative maintenance history screen, according to an embodiment of the present invention;

FIG. 29 is a diagrammatic illustration of a SMU update dialog, according to an embodiment of the present invention;

FIG. 30 is a diagrammatic illustration of a preventative maintenance checklist screen, according to an embodiment of the present invention;

FIG. 31 is a diagrammatic illustration of a parts list, according to an embodiment of the present invention;

FIG. 32 is a diagrammatic illustration of a preventative maintenance dialog, according to an embodiment of the present invention; and

FIG. 33 is a diagrammatic illustration of a preventative maintenance completed dialog, according to an embodiment of the present invention.

### DETAILED DESCRIPTION

With reference to the drawings and in operation, the present invention provides a fleet management system 100 for managing a plurality of machines 102, e.g., mobile or non-mobile machines. The present invention may be utilized with a number of different types of mobile and non-mobile machines, including engines, automobiles, mobile machines, construction, agricultural or earthmoving equipment, computers, electronics, consumer items (e.g., toasters, refrigerators, washers, etc . . . ), or any other item which it may be desirable to monitor.

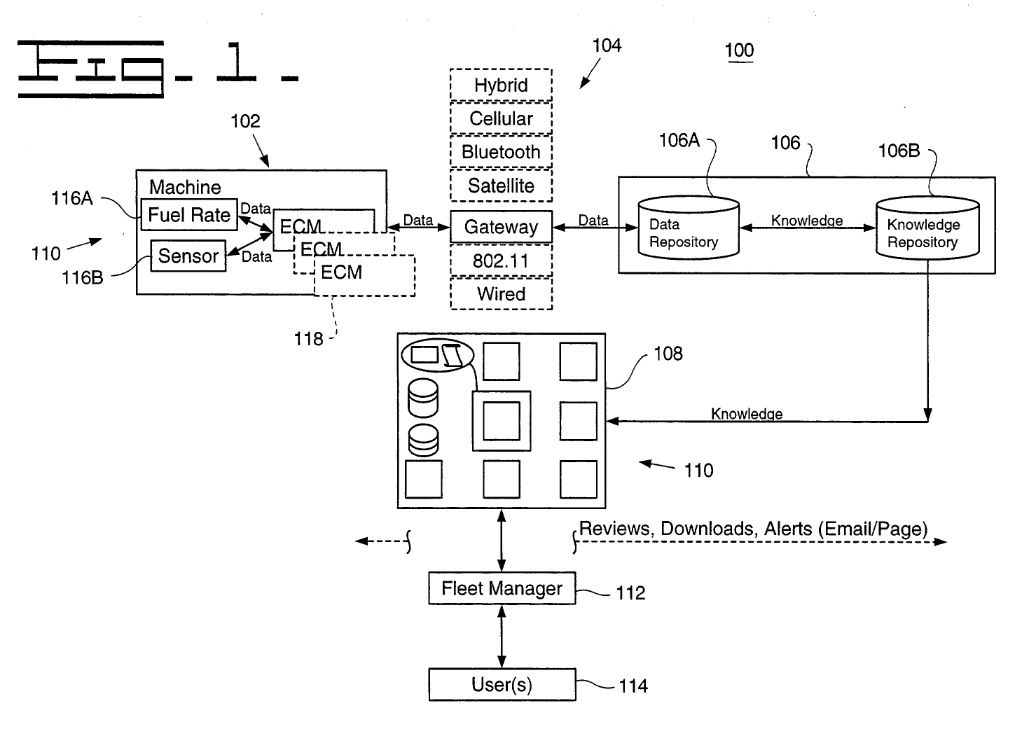

With specific reference to FIG. 1, the system 100 includes a communication conduit 104 coupled to the machines 102 for receiving status information related to the machines 102. In one aspect of the present invention, each machine 102 includes one or more sensors 116 for measuring machine parameters. In one embodiment, each machine includes a microprocessor based controller or information manager 118 for receiving signals from the one or more sensors, storing the data, and/or calculating other machine parameters based on the sensor data. For example, the machine 102 could be an earthmoving machine 102 having a fuel rate sensor 116A, a service hours sensor or meter 116B, and at least one controller or electronic control module 118 (ECM). The configuration may include one or more radio frequency identification (RFID) tags and/or readers.

The communication conduit 104 may include one or a combination of one or more of the following: satellite data link, cellular telephone communications link, radio link, bluetooth, 802.11, a wired communications link, or any other suitable wireless communications datalink. The communications conduit 104 used in a particular system may be dependent upon the nature of the machines 102 and the environment in which the machines 102 operate.

The system 100 also includes a repository 106 which is coupled to the communications conduit 104. In one embodiment, the repository 106 includes a data repository 106A and a knowledge repository 106B. The repository 106 is adapted to store the status information, as well as other information related to the machine 102 in the data repository 106A, e.g., historical data. The repository 106 is also adapted to store knowledge related to the machine 102 in the knowledge repository, e.g., machine specific information such as product maintenance schedules for the machines 102. The data and knowledge repositories 106A, 106B may be separate repositories or a single combined repository.

A fleet manager computer application 108 is run on a fleet manager controller 110. The fleet manager controller 110 is coupled to the repository 106 for analyzing the status information as a function of the historical and machine specification information. A user or users 114 may access the system 100 through one or more fleet managers 112 which are coupled to the fleet manager controller 110. The system 100 allows the user 114 to download or review the status information for any, all or a subset of the machines 102 (see below). The system 100 may also provide the user 114 with alerts or notifications via, e.g., pagers or email.

In one embodiment the fleet manager controller 110 is computer based. The fleet manager controller 110 may be accessed by the fleet managers 112, which may be implemented on one or more computers connected to a network, such as the internet. As explained below, different users 114 at different locations may have varying needs to access the system 100. Thus, the system 100 provides different levels of access or functionality at different locations.

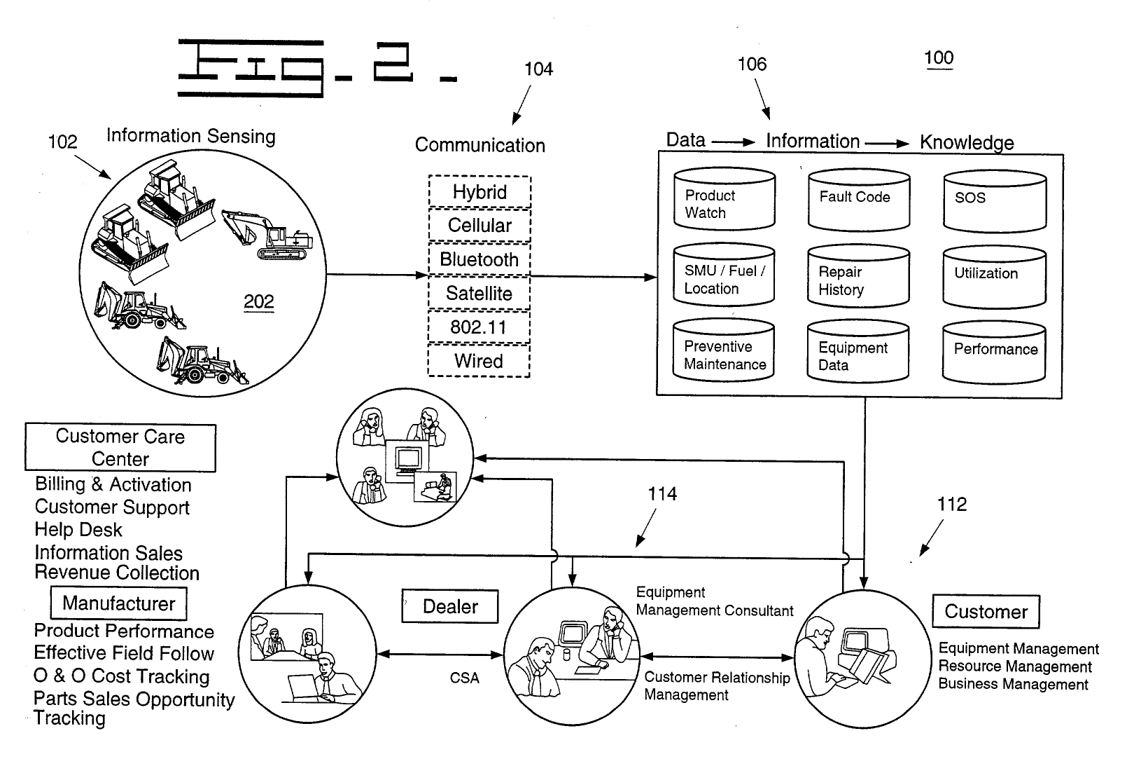

With reference to FIG. 2 in one exemplary application (where like items or numbered similarly), the system 100 is adapted to gather information form a plurality of construction equipment 202, such as excavators or bulldozers. The repository 106 stores information related to the construction equipment, such as product watch data 204, fault code data 206, scheduled oil sample (SOS) data 208, service meter hours, fuel, and location information 210, repair history data 212, utilization data 214, preventative maintenance data 216, and performance data 218.

The fleet manager 112 includes one or more computer applications which are located or accessible at various locations and accessed by users 114.

For example, the fleet manager 112 may include a customer care center application 220 located or accessible at a customer care center 222. The customer care center application 220 may provide the following functionality to one or more users 224: billing and activation, customer support, help desk, information sales, and revenue collection.

The fleet manager 112 may also include a manufacturer application 226 located or accessible at a manufacturer facility 228. The manufacturer application 226 may provide the following functionality to one or more users 230: product performance, effective field follow-up, owning and operating (O & O) cost tracking, and part sales opportunity tracking.

The fleet manager 112 may also include a dealer application 232 located at a dealer facility 234. The dealer application 232 may provide the following functionality to one or more users 236: equipment management consulting and customer relationship management.

The fleet manager 112 may also include a customer application 238 located or accessible at a customer facility 240. The customer application 238 may provide the following functionality to one or more users 242: equipment management, resource management, and business management.

The fleet manager 112 could be a web based interface that provides remote access to central applications. In addition, the fleet manager 112 could be a program executing on the remote computer which accesses the fleet manager controller 110.

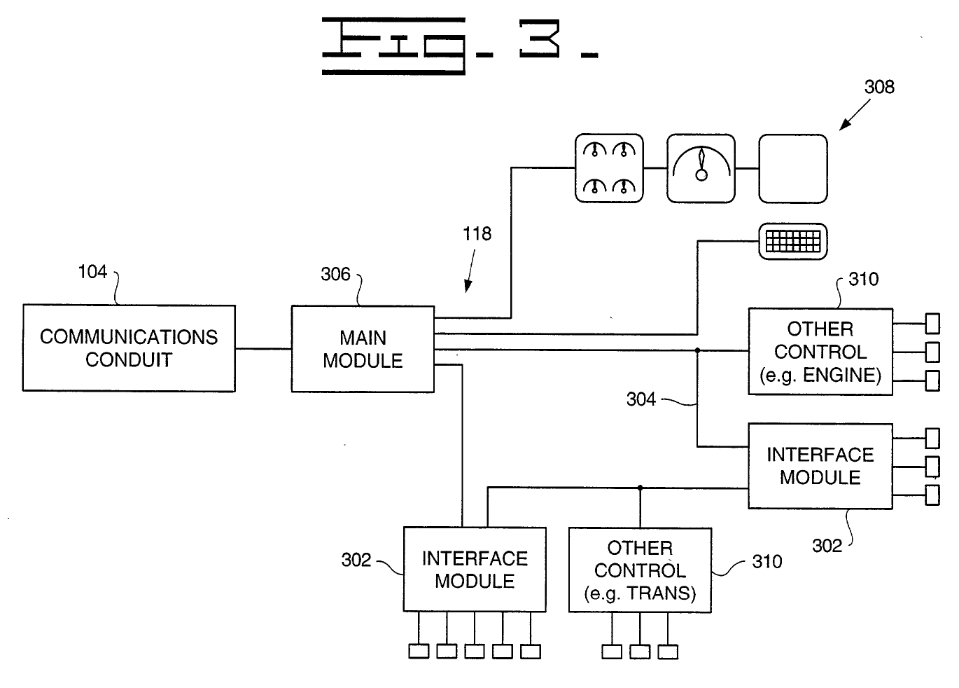

With reference to FIG. 3, an example of the information manager 118 on a mobile machine 102 is shown. The information manager 118 and a complement of onboard and off-board hardware software may be a data acquisition, analysis, storage, and display system for the machine 102. Employing the complement of on-board and off-board hardware and software, the information manager 118 will monitor and derive machine component information and make such information available to system 100.

Sensor data is gathered by interface modules 302 that communicate the data by a high-speed communication ring 304 (radio frequency or other communication techniques) to a main module 306, where it is manipulated and then stored until downloaded. It should be noted that while this describes the preferred embodiment, other suitable hardware arrangements may be used without deviating from the invention.

Subsets of the data are also transmitted to a display module 308 for presentation to an operator in the form of gauges, warning messages, and other forms of text and/or graphical information. During normal operation, gauge values are displayed in the operator compartment. During out-of-spec conditions, alarms and warning/instructional messages are also displayed. A keypad (not shown) may also be provided to allow entry of data and to allow system-level requests in the absence of a service tool. A message area is provided and includes a dot-matrix LCD to display text messages in the memory-resident language and International System of Units (SI) or non-SI units. A dedicated backlight will be employed for viewing this display in low ambient light conditions. The message area is used to present information regarding the state of the machine.

While the main, interface, and display modules 306, 302, 308 comprise the baseline information manager 118, additional on-board controls 310, such as engine and transmission controls, may be integrated into this architecture via the communication ring 304 in order to acquire the additional data being sensed or calculated by these controls and to provide a centralized display and storehouse for all on-board controls diagnostics.

Parameter data and system diagnostics are acquired from sensors and switches distributed about the machine 102 and from the other on-board controllers 310 . Data is categorized as either internal, sensed, communicated, or calculated depending on its source. Internal data is generated and maintained within the confines of the main module 306. Examples of internal data are the time of day and date. Sensed data is directly sampled by sensors connected to the interface modules and include pulse-width modulated sensor data, frequency-based data, and switch data that has been effectively debounced. Sensed data is broadcast on the communication ring 304 for capture by the main module 306 or one or more of the other on-board controllers 310. Communicated data is that data acquired by other on-board controllers 310 and broadcast over the communication ring 304 for capture by the main module 306. Calculated data channel values are based on internal, acquired, communicated, or the calculated data channels. Service meter, clutch slip, machine load, and fuel consumption are calculated parameters.

Data for download to system 100 from the main module 306 may include a header having a machine identifier, a time stamp of the download, and a definition table corresponding to the type of data being downloaded. For example, if trend data is to be downloaded, the definition table is a trend definition. The header is followed with the data described below and corresponding to a dependency definition table.

It should be noted that the above description of the information manager 118 on the machine 102 is for exemplary purposes only. Other architectures or schemes suitable for collecting and calculating parameter information may used without departing from the present invention. In addition, other message formats may be utilized.

Returning to FIG. 1, in one aspect of the present invention, the fleet manager controller 110 analyzes the status information and responsively determines a product maintenance recommendation.

In one embodiment of the present invention, the product maintenance recommendation is provided to one of the users 114. For example, the product maintenance recommendation may be provided via an email, a page (to a pager), an online report or a downloadable report.

In one embodiment, the machine specification information includes product maintenance schedule for each machine 102. The product maintenance recommendation is a modification to the product maintenance schedule (see below).

A product maintenance schedule may be defined in terms of service hours, i.e., hours of operation. Alternatively, the product maintenance schedule may be defined in other terms related to usage, such as miles or fuel usage. Additionally, a product maintenance schedule may have a plurality of product maintenance steps. Each step would include at least one action to be performed, e.g., changing engine oil.

For example, a product maintenance schedule for a machine 102 may include at least first and second maintenance steps. The first maintenance step is scheduled to be performed at X service hours and the second maintenance step is scheduled to be performed at Y service hours, where Y is greater than X. The status information may also include actual service hours.

In one embodiment, the first maintenance step includes at least one action. The second maintenance step includes the at least one action and at least one other action.

If actual service hours are less than X, then the product maintenance recommendation is to perform the first maintenance step at X service hours. Once the first maintenance step has been performed and actual service hours are greater than X, then the product maintenance recommendation is to perform the second maintenance step of Y service hours.

However, if the first maintenance step has not been performed and the recommended service hours at which the first maintenance step was recommended to be performed has passed, then the product maintenance recommendation may still be to perform the first maintenance step for a period of time and then to perform the second maintenance step.

Returning to our above example, after X service hours has passed and if the first maintenance step has not been performed, then the product maintenance recommendation may still be to perform the first maintenance step up until X+N service hours. After X+N service hours, where (X+N) is less than Y, then the product maintenance recommendation may be to perform the second maintenance step. In one embodiment N is equal to (Y−X)/2.

Other variations of the above are possible. For example, assume that there are four maintenance steps. Each step includes the following combination of recommended actions A, B, C, D.

Step 1: A (to be performed at W service hours),

Step 2: B (to be performed at X service hours),

Step 3: A and C (to be performed at Y service hours), and,

Step 4: B and D (to be performed at Z service hours).

The product maintenance recommendation is dependent upon the maintenance schedule and the machine specifications. For example, if Step 1 was not performed, and W+N₁, service hours had passed, then the product maintenance recommendation may to be perform Steps 1 and 2. If Step 2 was not performed, and X+N2 service hours had passed, then the product maintenance recommendation may be to perform Steps 2 and 3. Likewise, if Step 3 was not performed, and Y+N 3 service hours had passed, then the product maintenance recommendation may be to perform Steps 3 and 4. In addition, if Step 1 was not performed, and the time is between W and X, recommended action B may be accelerated, e.g., Steps 1 and 2 may be performed at the same time and the remaining maintenance schedule may be modified accordingly (as needed).

Similar recommendations would be made if consecutive maintenance steps were missed.

In one embodiment, the product maintenance recommendations are categorized, i.e., assigned a status code, based on their importance. For example, a product maintenance recommendation may be categorized as Action, Normal, or Monitor. A color may be associated with each category, e.g., Red, Green, and Yellow, respectively. Generally, a Normal categorization requires no action, e.g., a problem has just been corrected and/or scheduled maintenance has just been performed. A product maintenance recommendation categorized as Monitor may mean that an product maintenance step is coming up or that an on-board fault has been detected. A product maintenance recommendation categorized as Action may mean that a product maintenance step is due or overdue or that an onboard fault has been detected and needs action.

In one embodiment, the product maintenance recommendation is displayed to an operator of the machine at the machine.

As described below, the operation of the machine or the user of the system 100 (who may be reviewing a subset of machines), may drill or expand into each product maintenance recommendation for additional information on a particular machine or product maintenance recommendation.

In another aspect of the present invention, the fleet manager controller 110 is adapted to modify the product maintenance schedule.

In one embodiment, the computer application 108 is adapted to modify the product maintenance schedule in response to input from a user. For example, the owner or operator of a piece of equipment or mobile machine may modify the product maintenance schedule in response to the environmental operating conditions of the piece of equipment. If, for example, the piece of equipment is operating in a harsh environment, the user 114 may reduce the number of service hours between each scheduled maintenance step.

In one embodiment, there may be a default maintenance schedule base on the application being performed, e.g., on-highway, off-highway, construction, mining, etc . . .

In additional, the location of the work may be accounted for. For example, different climates may have different impacts on maintenance needs. Also different geographical regions, e.g., coastal vs. inland, may impact the maintenance schedule. Furthermore, the time of the year may also impact the maintenance schedule. Therefore, in one embodiment, preventative maintenance may be dynamically determined and updated as a function of one or more parameters, including the application, climate, location, etc . . . In one aspect the computer application 108 includes one or more pre-defined maintenance schedules and selects an appropriate schedule as a function of one or more parameters. In another aspect, the computer application 108 may dynamically determine an appropriate maintenance schedule and update as conditions change. Furthermore, the maintenance schedule may be modified in real time as a function of additional parameters, e.g., fuel usage, service meter hours, severity of application, weather, etc . . .

In another embodiment, the fleet manager controller 110 is adapted to modify the product maintenance schedule as a function of when a scheduled maintenance step was performed. For example, if a schedule maintenance step was performed at +/− n service hours from its scheduled service hours, than the product maintenance schedule may be modified to adjust for this offset, i.e., retain N service hours between scheduled maintenance steps.

In another aspect of the present invention, the fleet manager 110 is adapted to choose a desired number of machines 102 to view. The selection may be based on input from a user 114, e.g., the identity of the user 114. In other words, a user 114 may be allowed to access information about one or more machines 102. Different users 114 may have different subsets of machines 102 which are being monitored. For example, an owner or operator may own a plurality of machines 102 which are located at different sites. Or a dealer may be using the system 100 to monitor the fleets of different customers.

In another aspect of the present invention, the fleet manager controller 110 tracks at least one event for the plurality of machines 102. Examples, of events which may be tracked include parameters, such as service hours, oil level, fuel level, geographic location, time of operation, etc . . . Events may also include trip or activity recording events, location (two dimensional or 3 dimensional), weather, etc. Two dimensional or three dimensional position information may be displayed via the system 100 to the user or to an operator of the machine. The system 100 may also use the three-dimensional position information for performing real-time surveying of a jobsite using the machine.

Events may also be triggered events related to the parameters. For example, when a given parameter is above a predetermined value or when a rate of change of the given parameter exceeds predetermined value. Parameter values may also be subject to a trend analysis. As discussed, above parameter values may be either sensed data or calculated based on sensor data. The calculated values may be determined onboard or off-board. The status information may include the parameter or calculated values.

In one aspect of the present invention, events (including status information and historical information) may be trended (in real-time or at a later time) to identify issues before they arise. The trend analysis may include identifying a highest or a plurality of the highest recurring problems associated with a plurality of machines or a subset of machines. The trending analysis may also be utilized to identify the utilization of a plurality of machines or a subset of the machines. The trending analysis may further be used to identify time and/or a meantime between failures.

In another aspect of the present invention, the trending of one or more parameters may be used to modify the product maintenance schedule. For example, increased fuel usage may indicate that additional maintenance is required or that the product maintenance schedule should be sped up.

Furthermore, the trending analysis may be used to identify a severity of an application, for example, low, medium, or high. In one embodiment, the severity of the application may be based on parameters and/or the trending of parameters including one or more of the following: fuel usage, power ratings, machine movements (including time within certain portions of a work cycle), the number of loads, or other machine movements. As described below, the machine scheduled maintenance may be modified as a function of the severity of the application.

In one aspect of the present invention, information or parameters from a plurality of machines may be trended to make determinations relative to an application, an (operating) environment, climate, a job or job site, a type of machine or a plurality of machine. The product maintenance schedule for a machine or a subset machines, such as all machines at a particular job or job site or all machines of a particular model or type, may be adjusted.

Trended data may also be used to determine where a machine is relative to its expected machine life and to adjust its product maintenance schedule as a function thereof. A machine may also be compared with the aggregate trends of other machines, e.g., of the same type or model, at the same or similar job site or application, environment type, climate type, etc . . . , to determine machine health status based on the trend comparison.

In one embodiment of the present invention, an event may defined as a function of time. For example, a user 114 may define that a group of machines 102 or machine 102 may only be operated at a certain location (within a given radius) or during a certain time interval. A fault code may be generated when the machine 102 is operated outside of the time and location boundaries. The event may by defined as being inclusive or exclusive. In other words, the machine may be operated only during these hours or cannot be operated during these hours. In addition, the machine may be operated only within a particular area or outside a particular area. In one embodiment, a status message may be generated when the machine comes within a boundary, e.g., a fuel or maintenance depo. The machine 102 may also include a security system (not shown). The security system may be keyed or designed to allow only authorized persons from operating the machine, through the use of a password, personal identification number, radio frequency identification, or the like. The security system may also include a remote disable feature which allows the system 100 to automatically (or at the request of a user) disable the machine 102 so that it cannot be operated. For example, if a fault code is generated indicated a geographic or time out-of-bounds, then the system 100 may trigger the security system to disable the machine.

As discussed above, the fleet management system 100 may contain components of the fleet manager 112 at different sites, e.g., the manufacturer, a dealer, or a customer. In one embodiment, the fleet manager controller 110 is adapted to allow a user 242 located at the customer facility 240 to request a quote from the dealer related to the recommended maintenance step. Additionally, the fleet manager controller 110 may be adapted to schedule a recommended maintenance step, either at their own repair maintenance facility, at the dealer facility 234, or schedule the maintenance to be performed in the field.

In another aspect of the present invention, the fleet manager controller 110 is adapted to mark a maintenance step as having been completed. In one embodiment, the maintenance step is marked as having been completed manually by a user 114, e.g., by the owner, operator, or person(s) performing the maintenance step. Alternatively, the onboard information manager 119 may also automatically detect that a maintenance step has been performed and automatically updated the step as having been completed on the system 100.

In another aspect of the present invention, the fleet manager controller 110 is adapted to display a list of parts required for a recommended maintenance step. Additionally, a user 114, e.g., the dealer or the customer may either check inventory to ensure that the parts are in inventory or order the part. The system 100 may also be adapted to automatically order the parts for upcoming maintenance steps, check inventory for the required parts, or check inventory levels and order parts if inventory levels or expected inventory levels fall below a predetermined level. For example, if the owner is the operator of a mine site, the system 110 may automatically order parts when maintenance is due or is scheduled. Additionally, if the part is in inventory, the system 100 may reserve the part. Furthermore, if more than one machine is scheduled for maintenance which requires a particular part, then the system 100 recognizes this and orders additional parts.

In addition to ordering or reserving parts, the system 100 may automatically order transportation for a part as needed. For example, if the part must be ordered from the manufacturer or dealer, the system 100 may also automatically schedule transportation for the part to the owner of the machines (or the dealer).

In addition to scheduling maintenance, the system 100 may also schedule transportation for the machine (as needed) to perform the needed maintenance or schedule the maintenance via a portable maintenance truck or vehicle.

In another aspect of the present invention, the fleet manager controller 110 is adapted to analyze a utilization of the machine(s) 102 as a function of the historical data.

In another aspect of the present invention, the fleet manager controller 110 is adapted to analyze the performance of the machine(s) 102 as a function of the historical data. For example, the fleet manager controller 110 may dynamically determine if one or more machines 102 are being under utilized or if there are performance issues with one or more machines. Furthermore, the fleet manager controller 110 may dynamically determine if another machine may be used.

In still another aspect of the present invention, the system 100 may automatically provide software updates to the machines or configure software based on operator expertise, the job site or other conditions, such as environmental.

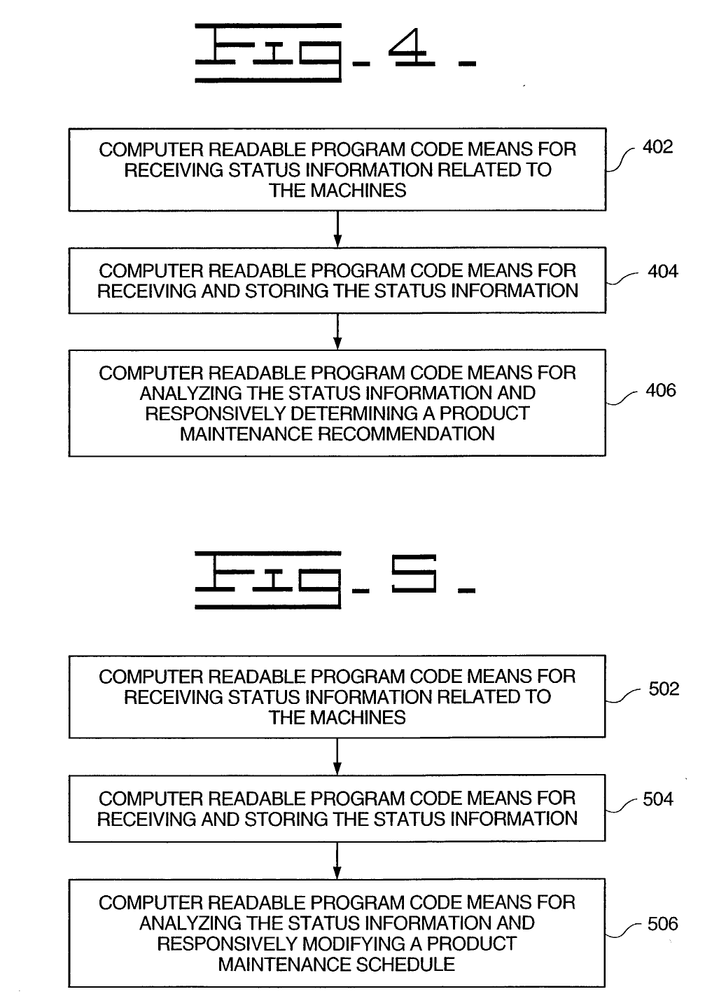

With reference to FIG. 4 in one aspect of the present invention, a computer readable program product 400 configured to managing a plurality of machines 102 is provided. The computer readable program product 400 includes computer readable program code means 402 for receiving status information related to the machines 102 and computer readable program code means 404 for receiving and storing the status information in the repository 106. The computer readable program product 400 also includes computer readable program code means 406 for analyzing the status information as a function of historical and machine specification information and responsively determining a product maintenance recommendation.

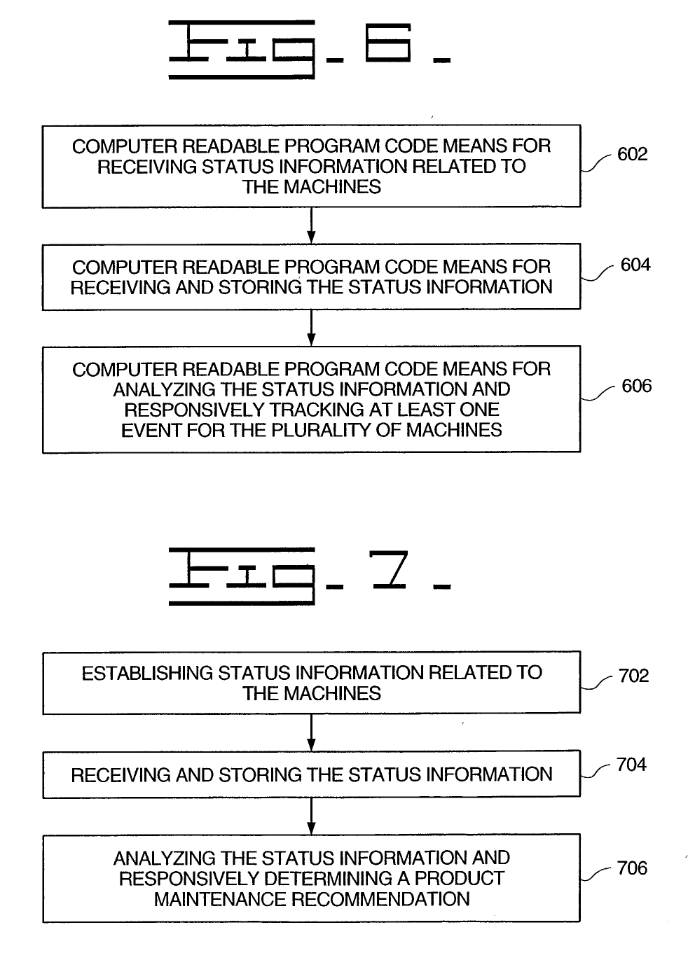

With reference to FIG. 5 in another aspect of the present invention, a computer readable program product 500 for managing a plurality of machines 102 is provided. The computer readable program product 500 includes computer readable program code means 502 for receiving status information related to the machines 102 and computer readable program code means 504 for receiving and storing the status information in a the repository 106. The computer readable program product 500 also includes computer readable program code means 506 for analyzing the status information as a function of the historical and machine specification information and responsively modifying the product maintenance schedule.

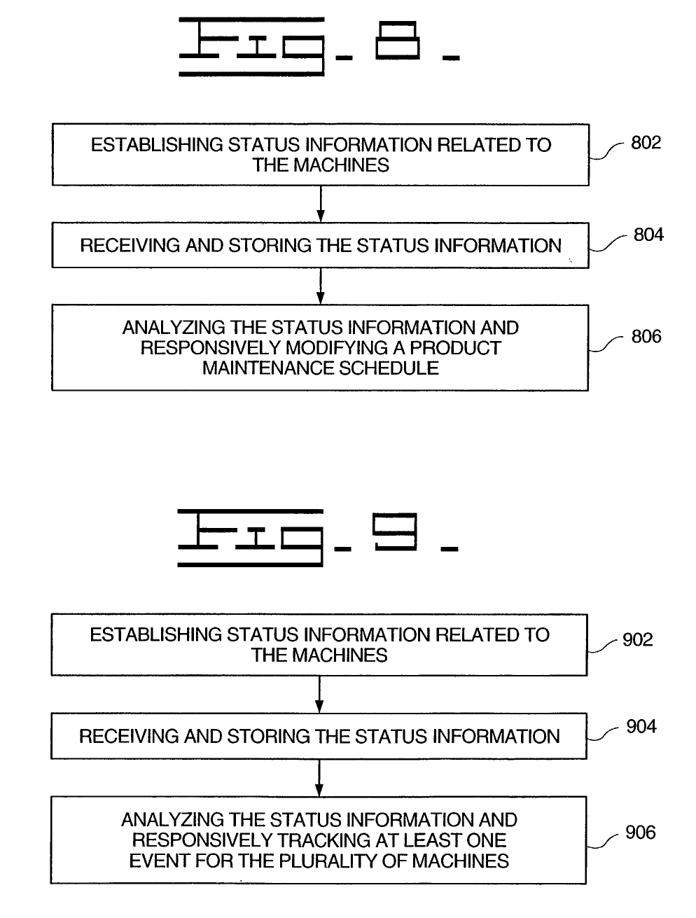

With reference to FIG. 6 in still another aspect of the present invention, a computer readable program product 600 for managing a plurality of machines 102 is provided. The computer readable program product 600 includes computer readable program code means 502 for receiving status information related to the machines 102 and computer readable program code means 604 for receiving and storing the status information in the repository 106. The computer readable program product 600 also includes computer readable program code means 606 for analyzing the status information as a function of the historical and machine specification information and tracking at least one event for the plurality of machines 102.related to one of location and time.

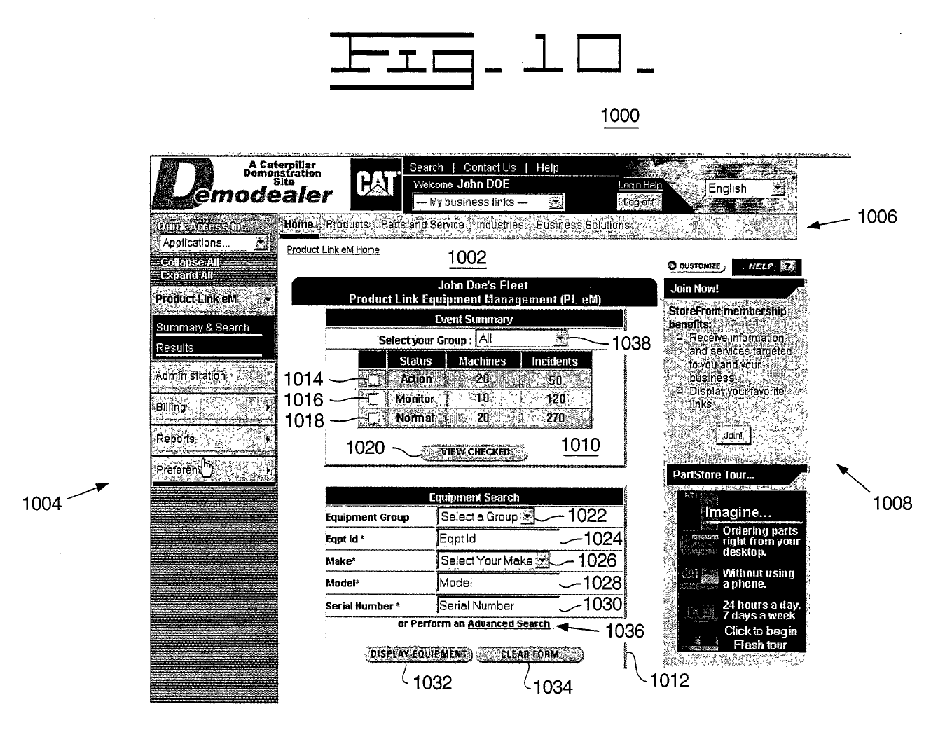

With reference to FIG. 7 in one aspect of the present invention, a method 700 for managing a plurality of machines 102 is provided. The method 700 includes a first process step 702 of establishing status information related to the machines 102 and a second process step 704 of receiving and storing the status information at the repository 106. The method 700 also includes a third process step 706 of analyzing the status information as a function of the historical and machine specification information and responsively determining a product maintenance recommendation.

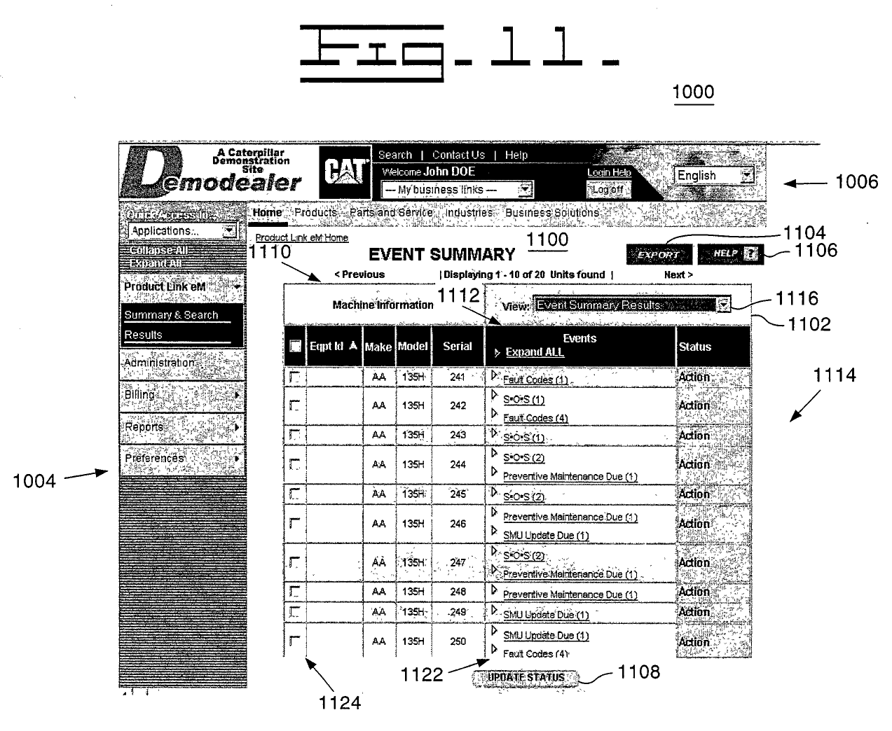

With reference to FIG. 8, in another aspect of the present invention, a method 800 for managing a plurality of machines 102 is provided. The method 800 includes a fourth process step 802 of establishing status information related to the machines 102 and a fifth process step 804 of receiving and storing the status information in a repository 106. The method 800 also includes a sixth process step 806 of analyzing the status information as a function of the historical and machine specification information and responsively modifying the product maintenance schedule.

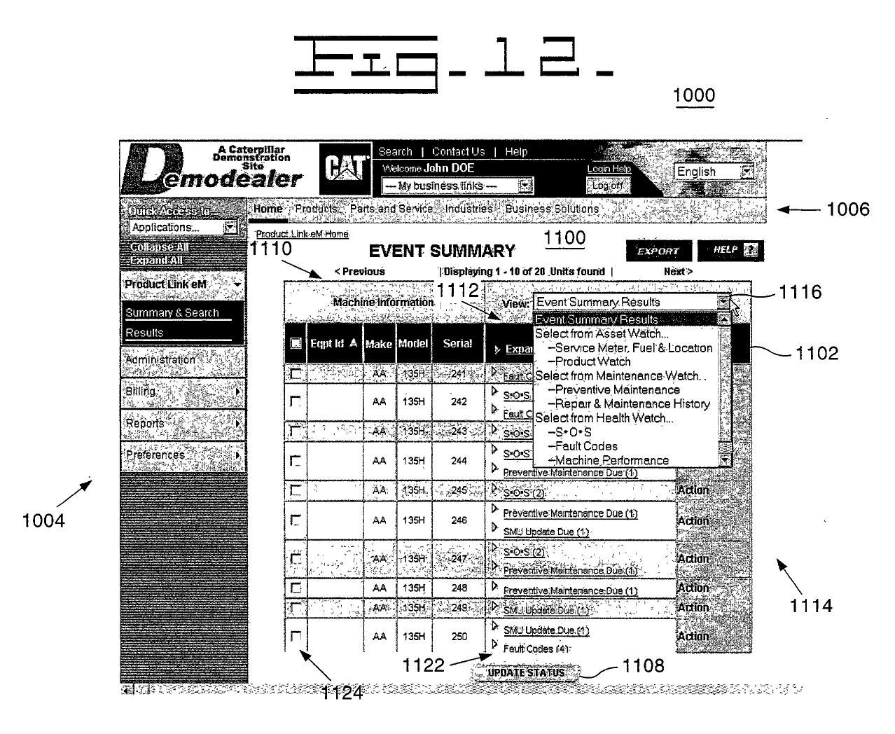

With reference to FIG. 9, in still another aspect of the present invention, a method 900 for managing a plurality of machines 102 is provided. The method 900 includes a seventh process step 902 of establishing status information related to the machines 102 and an eighth process set 904 of receiving and storing the status information in a repository 106. The method 900 also includes a ninth process step 906 of analyzing the status information as a function of the historical and machine specification information and tracking at least one event, related to location or time, for the plurality of machines 102, the event being.

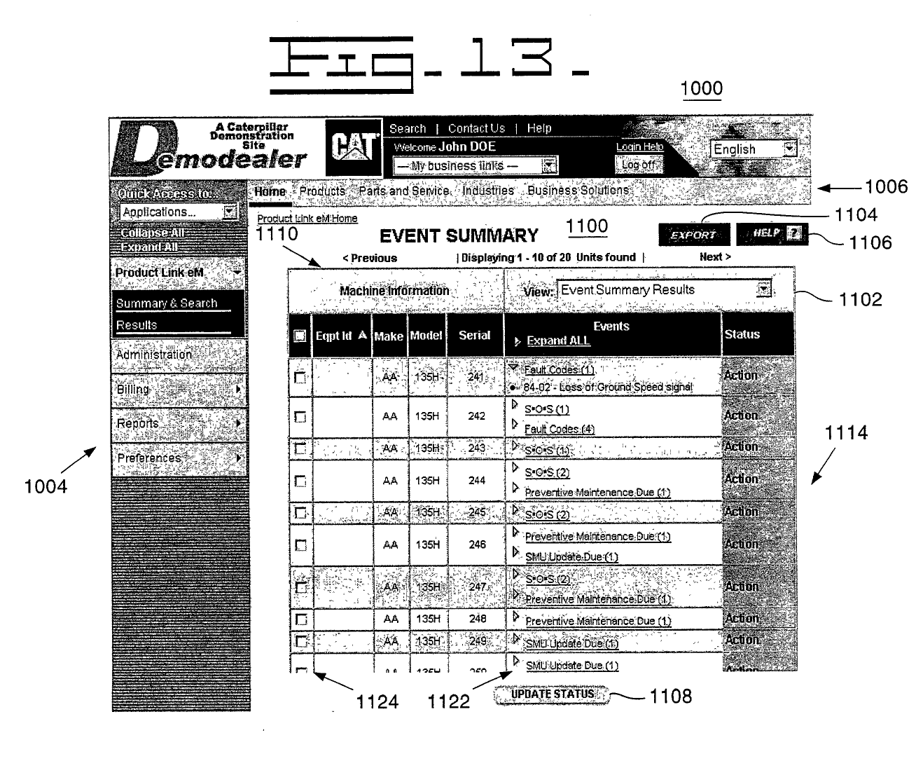

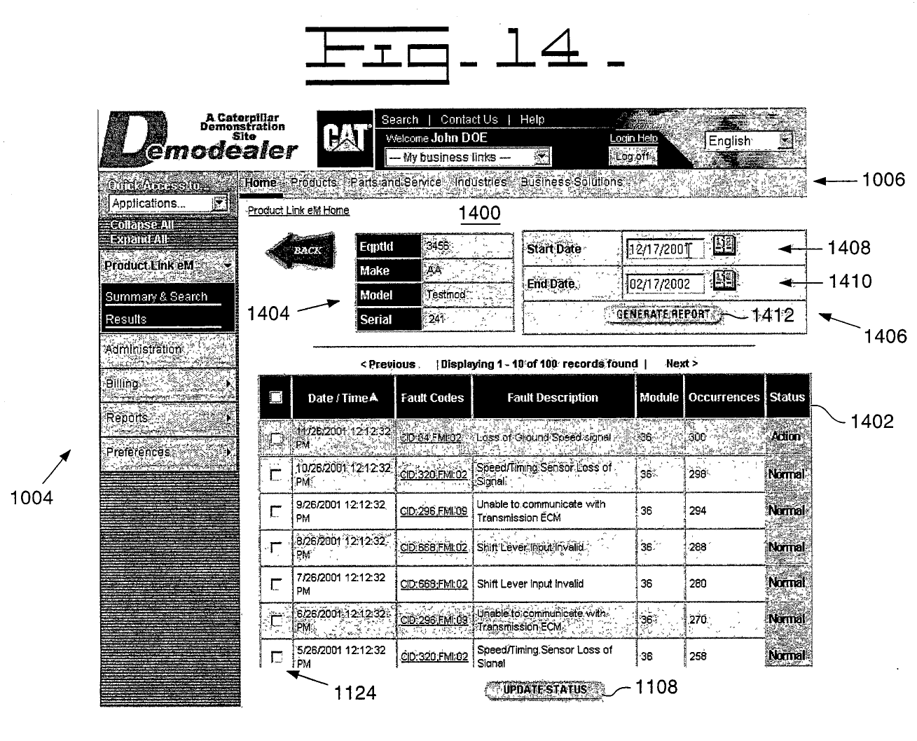

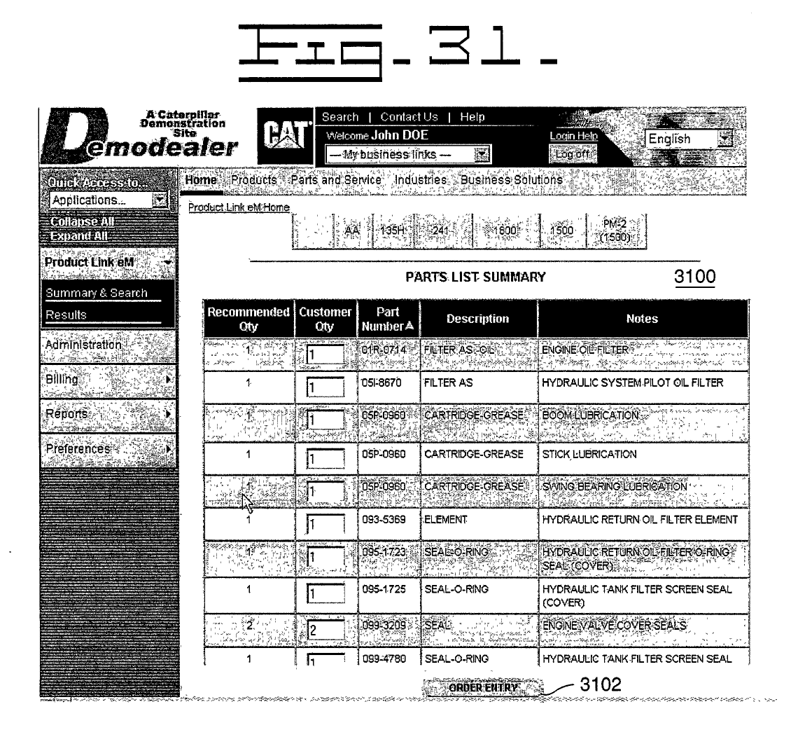

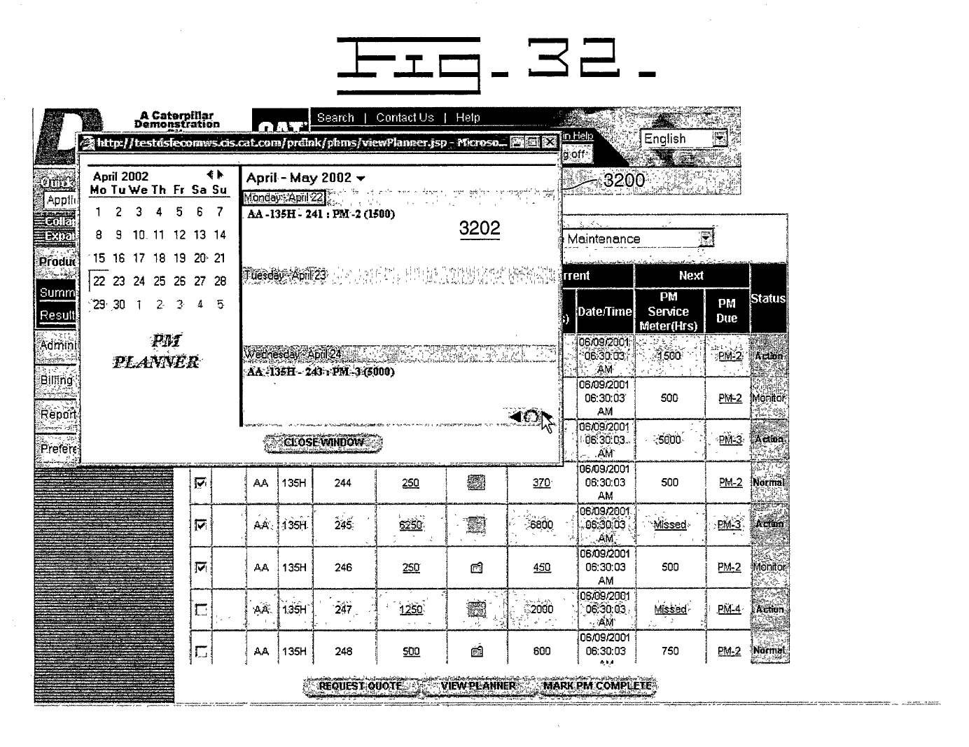

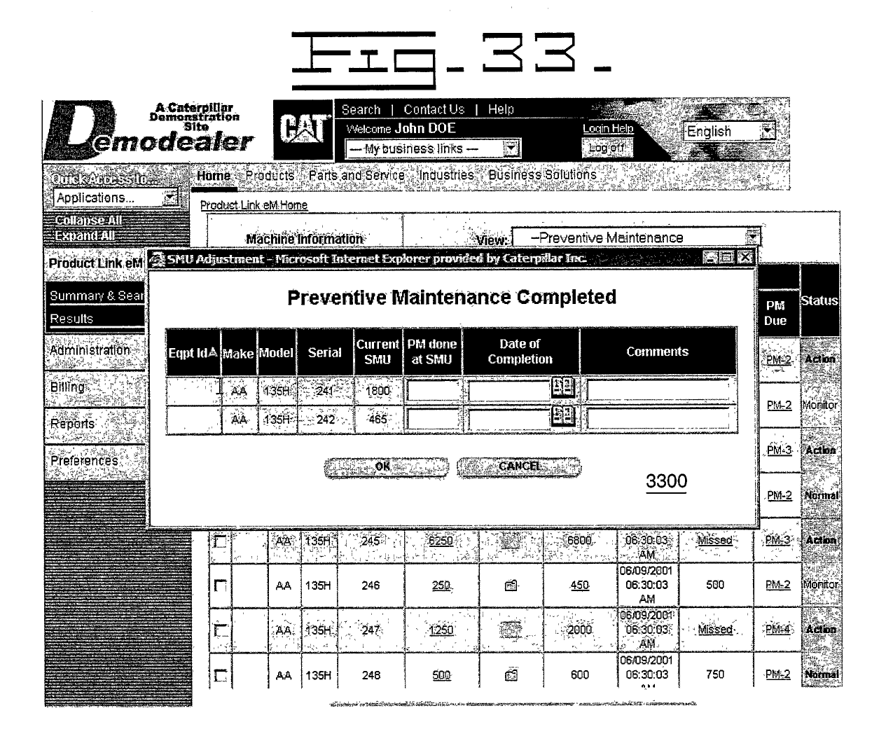

With reference to FIGS. 10-33, in one aspect of the present invention, the fleet manager 112 at each location includes a front end or graphic user interface (GUI) 1000 which allows the various users 114 to access the system 100. In one embodiment, the fleet manager 112 is coupled to the system 100 via a network such as the internet. In an alternative embodiment, the GUI 1000 is accessed using a web browser such as Internet Explorer available from Microsoft Corporation of Redmond, WA. Therefore, the fleet manager 112 is the portion of the computer application 108 that is displayed to the user 114 or provided to the user 114 by the computer application 108, to access the system 100.

As discussed above, the fleet manager 112 at each location (e.g., customer service location, customer, dealer, manufacturer) may provides different functionality. Thus, the information or functionality may vary. For purposes of explanation, the example shown is provided by a dealer of the equipment and made available to its customers.

With specific reference to FIG. 10, the general layout of an user introductory screen 1002 of the GUI 1000 is shown. The current user 114 of the system 100 is John Doe. The introductory screen 1002 includes a side menu bar 1004 and a top menu bar 1006. Various functions of the system 100 are available through the side menu bar 1004. The side menu bar 1004 and the top menu bar 1006 also provide access to other functions made available by the dealer such as administration, billing, reports, preferences, products, parts and service, and business solutions. Other options may be made available in a side bar 1008, such membership in dealer group and access to newsletters.

The introductory screen 1002 includes an event summary access table 1010 and an equipment search box 1012.

The event summary access table 1010 allows the user 114 to select the machines (from his available machines) of which the user 114 wishes to review. As shown, Mr. Doe has access to information regarding a plurality of machines. Of the machines 102 available to Mr. Forcash, there are 50 events or incidents (on twenty machines 102) classified as Action, 120 incidents (on 10 machines) classified as Monitor and 270 incidents (on 20 machines) classified as Normal. The event summary access table 1010 includes a select your group drop down list 1038, an action check box 1014, a monitor check box 1016, a normal check box 1018, and a view checked button 1020. Machines may also be grouped by other parameters such as job number, operator, site, etc . . .

In one embodiment, different users 114 will have different access rights. For example, a foreman may have access to a particular group of machines, while a supervisor foreman may have access rights to those machines, plus other machines under their management.

As discussed above, the machines 102 available to a user 114 may be further categorized into subsets. The select your group drop down list 1038 allows the user 114 to select the group or subset or all of the machines (as shown) that the user wants to review. The action check box 1014, a monitor check box 1016, and the normal check box 1018 allows the user 114 to further define or limit the events or incidents to review. After the user 114 selected the appropriate options, selection of the view checked button 1020 displays all requests incidents or events (see below).

The equipment search box 1012 allows the user 114 to select particular machines by desired criteria. The equipment search box 1012 includes a group drop down list 1013, an equipment id entry box 1024, a make drop down list 1026, a model entry box 1028, and a serial number entry box 1030. The equipment search box 1012 also includes a display equipment button 1032 and a clear form button 1034. Selection of the clear form button 1034 clears any entered data on the equipment search box 1012. The user 114 may enter information to select the desired machines 102 and select the display equipment button 1032. Additionally, an advanced search link 1036 allows the user 114 to enter additional information to refine the search.

With reference to FIGS. 11-14, with selection of either the view checked box 1020 or the display equipment button 1032, an event summary screen 1100 is displayed on the GUI 1000. The event summary screen 1100 displays an event list 1102 containing all of the events for the selected machines 102. The event summary screen 1100 includes an export button 1104, a help button 1106, and an update status button 1108. The export button 1104 allows the information displayed in the event list 1102 into a downloadable file, e.g., into a Microsoft Excel file. The help button 1106 provides access to help files. Selection of the refreshes or updates the event summary list 1102.

As discussed above, the event summary list 1102 lists all of the current events for the selected machines 102. The event summary list 1102 includes a machine information section 1110, an events section 1112, and a status section 1114. For each event, the machine information section 1110 provides identification information for the relevant machine 102, such as, equipment identification, make, model, and serial number. The events section 1112 lists all of the events for the selected machines 102, while the status section 1114 displays the status or code for the listed events. In the illustrated embodiment, the events are listed according to their code, in the following order: Action, Monitor, Normal.

In the illustrated example, the following types of events are shown: fault codes (received from a machine 102), scheduled oil sample (SOS) data, preventative maintenance due, and service meter unit update due. The service meter unit update due refers to a machine which requires that service meter hours be input manually. 11251 The event summary table 1102 also includes a view drop down list 1116. The view drop down list 1116 allows the user 114 to select the desired data to be viewed. In the illustrated embodiment, the available information is categorized in the following categories: Event Summary Results (shown), Asset Watch, Maintenance Watch, Health Watch. The information available in each category is listed below.

Asset Watch

service meter, fuel & location

inclusion/exclusion time and/or location information

Maintenance Watch

preventative maintenance

repair and maintenance history

Health Watch

scheduled oil sample data.

fault codes

machine performance

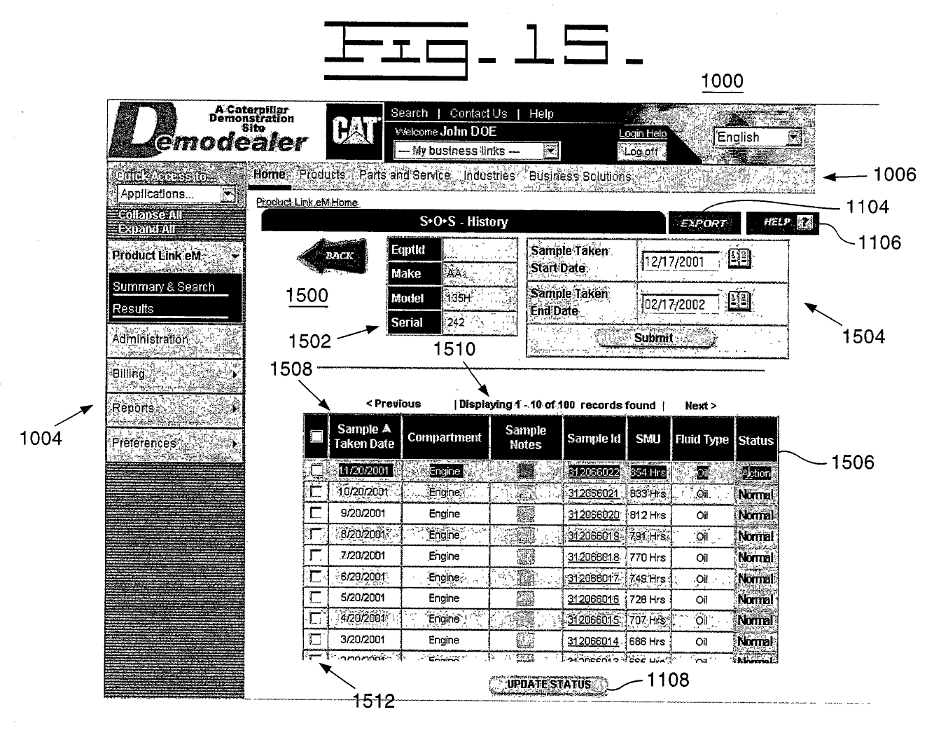

With reference to FIG. 11, each of the events listed in the events section 1112 may be expanded with more detail. In the illustrated embodiment, all of the listed events may be expanded by selecting an expand all link 1120. The events may be individually expanded by selection of an arrow 1122 next to each event. With particular reference to FIG. 13, the first event, “Fault Codes (1)”, has been expanded to give more detail (“Loss of Ground Speed Signal”).

Each event in the machine information section 1110 also includes a check box 1124. A checkbox 1124 at the top of the machine information section 1110 selects all events. Selection of the update status button 1108 refreshes or updates the selected events.

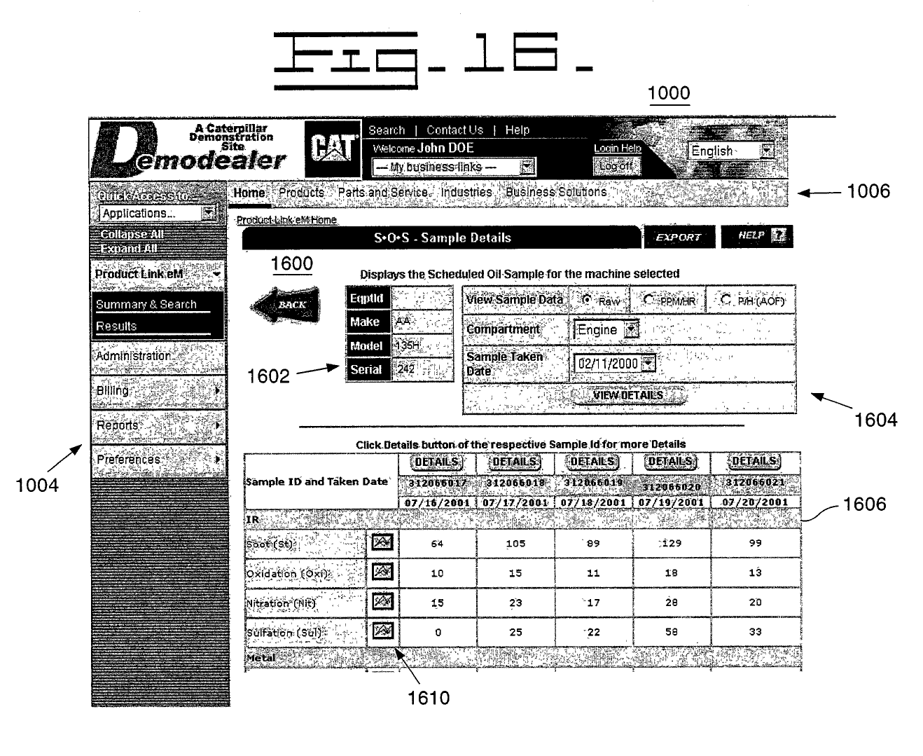

With reference to FIGS. 11 and 14, each of the events is also a hyper link. In other words, selection of the event displays additional information or options related to that event, such as descriptive material, a parts list, and/or options to schedule service or maintenance and/or order parts.

For example, selection of the first fault code listed in the table 1102 displays an event screen 1400. The event screen 1400 includes an event list 1402 containing all recent similar events (here, all recent fault codes) for the same machine in a given period. The event screen 1400 include a machine identification section 1404 and a report section

The machine identification section 1404 contains machine identification information, such as, equipment identification, make, model, and serial number.

The event screen 1400 lists all recent events in a default period, e.g., the previous three months. The report section 1406 allows the user 114 to specify a data range to be included in the report. As shown, the report section 1406 includes first and second calendars 1408, 1410 which allow the user to enter or define start and end dates. The report section 1406 also includes a generate report button 1412. Selection of the generate report button 1412 updates the event list 1402 using the specified date range. An export button (not shown), may also be provided to allow the user to export the report to a file.

Component life may also be tracked. Component life may be tracked using a static parameter such as operating or service meter hours or using a plurality of parameters such as operating hours, fuel rate, oil condition . . . Component life tracking may give an indication of when repair will be needed, i.e., when the component life is about to expire. The system 100 allows the required repair or maintenance to be planned or schedules, prepares or displays a maintenance parts list and automatically orders or reserves the required parts (see below).

In one aspect of the present invention, the data stored by the system 100 may be used in an equipment certification process (for resale purposes).

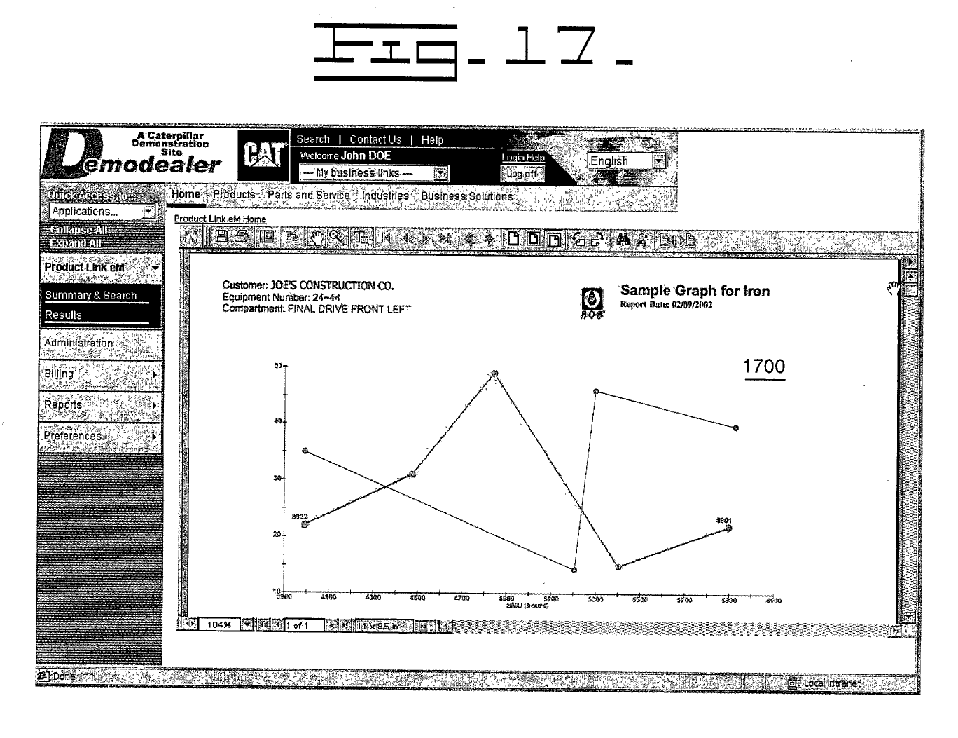

With reference to FIGS. 15-18, selection of one the scheduled oil sample data links in the event list 1102 displays a SOS history screen 1500. The SOS history screen 1500 includes a machine identification section 1502, a sample report section 1504, and a sample list 1506. The machine identification section 1502 provides information related to the machine 102 corresponding to the selected event. The sample list 1506 lists all scheduled oil samples in the set time period, e.g., the last three months. The sample report section 1504 allows the user 114 to define a new start and end date and to generate a new report using the defined dates.

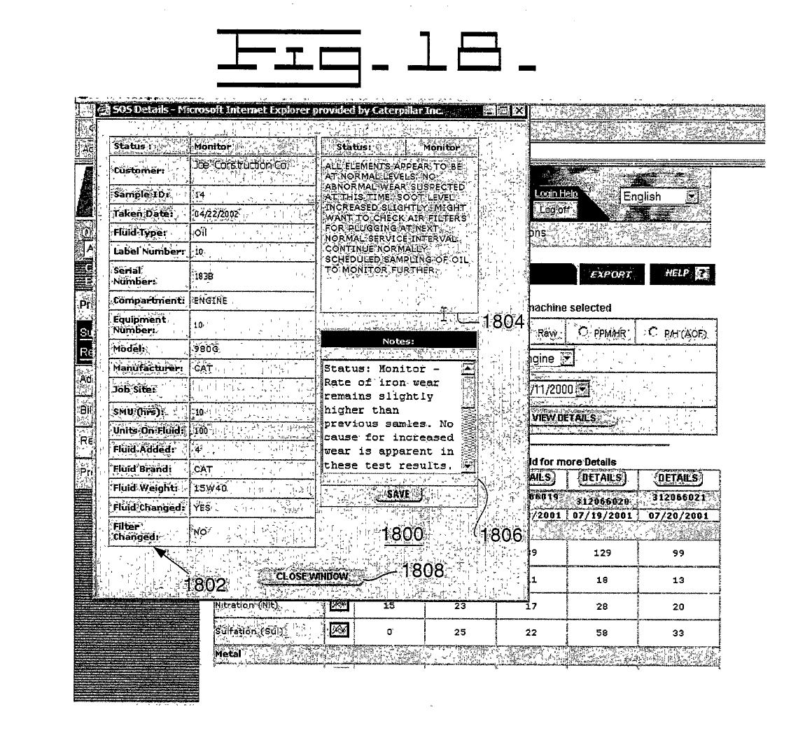

The sample list 1506 includes a date section 1508 and an information section 1510 which provides additional information for each sample, such as the compartment from which the sample was taken, notes, a sample identification, service hours, fluid type, and a status code. Each sample also has a corresponding check box 1512 which is used to select sample. Selection of the update status button 1108 updates the status of the selected samples. As shown, each sample id is a hyper link. With reference FIG. 16, selection of a sample id displays a SOS sample details screen 1600. The SOS sample details screen 1602 includes a machine identification section 1602, a sample report section 1604, and a details section 1606. The sample report section 1604 allows the user 114 to modify the information displayed in the details section 1606. In the exemplary details section 1606, information is divided into three sections: IR, Metal and Physical. Each section provides additionally information regarding parameters, such as soot or oxidation. The details section provides a details button 1608 for each sample date and a graph icon 1610 for each (or some) of the parameters in each section.

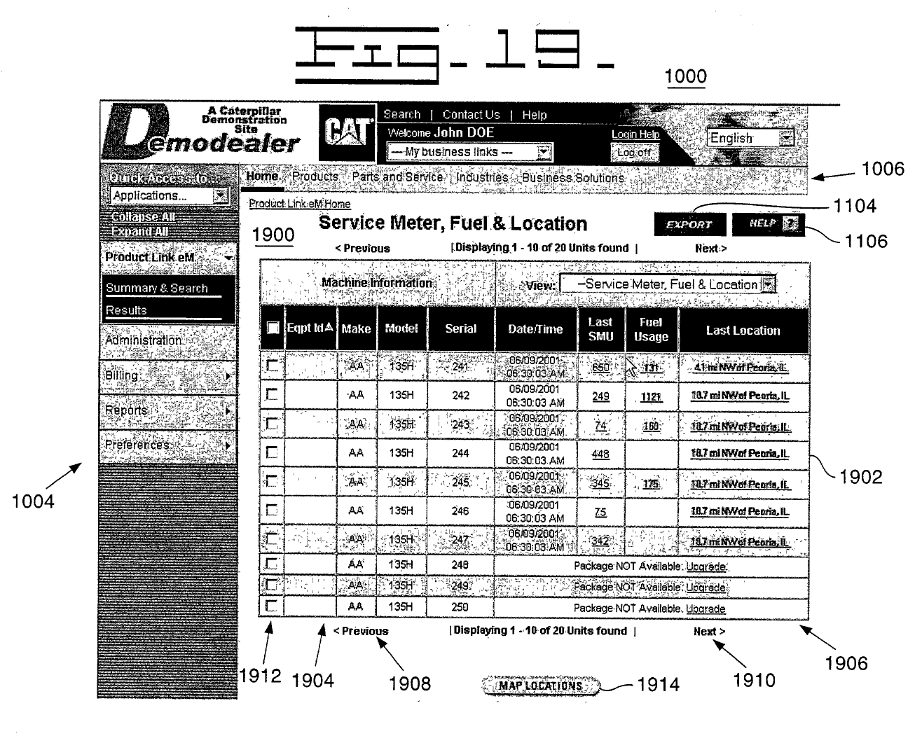

With particular reference to FIG. 17, selection of the graph icon 1610 for a given parameter displays a corresponding graph 1700.

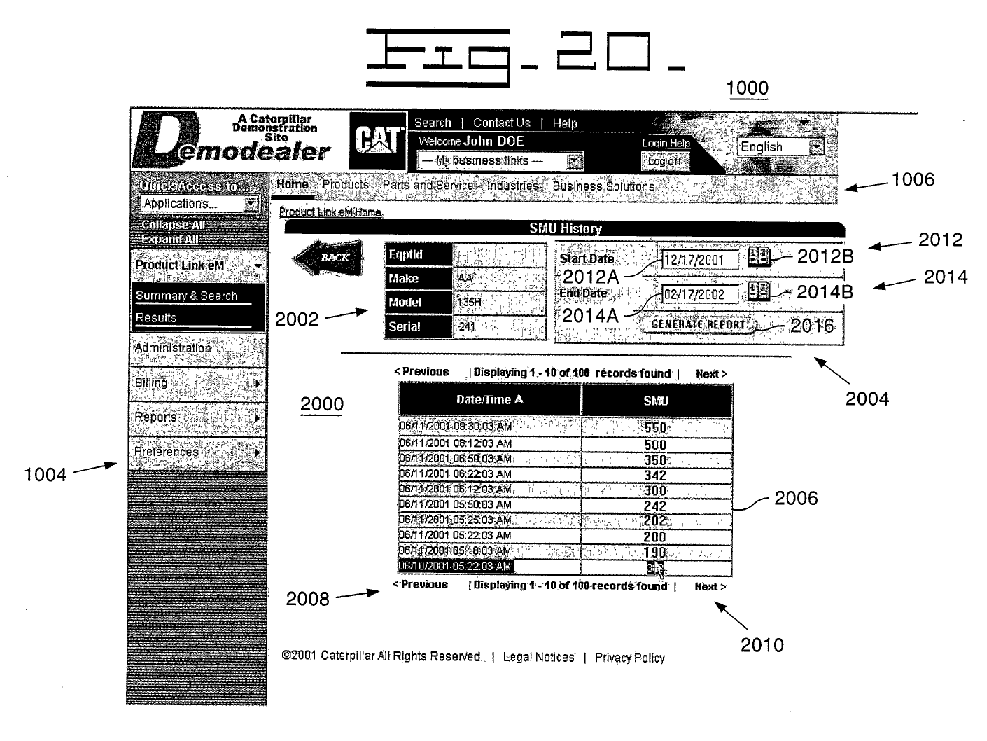

With particular reference to FIG. 18, selection of the details button 1608 for a particular sample date, displays a details dialog 1800 containing additional information. The details dialog 1800 includes an identification section 1802, a status section 1804, and a notes section 1806. The notes section 1806 allows the user to add notes to the sample data. The notes are also available in the sample list 1506. The details dialog 1800 may be closed by selection a close button 1808.

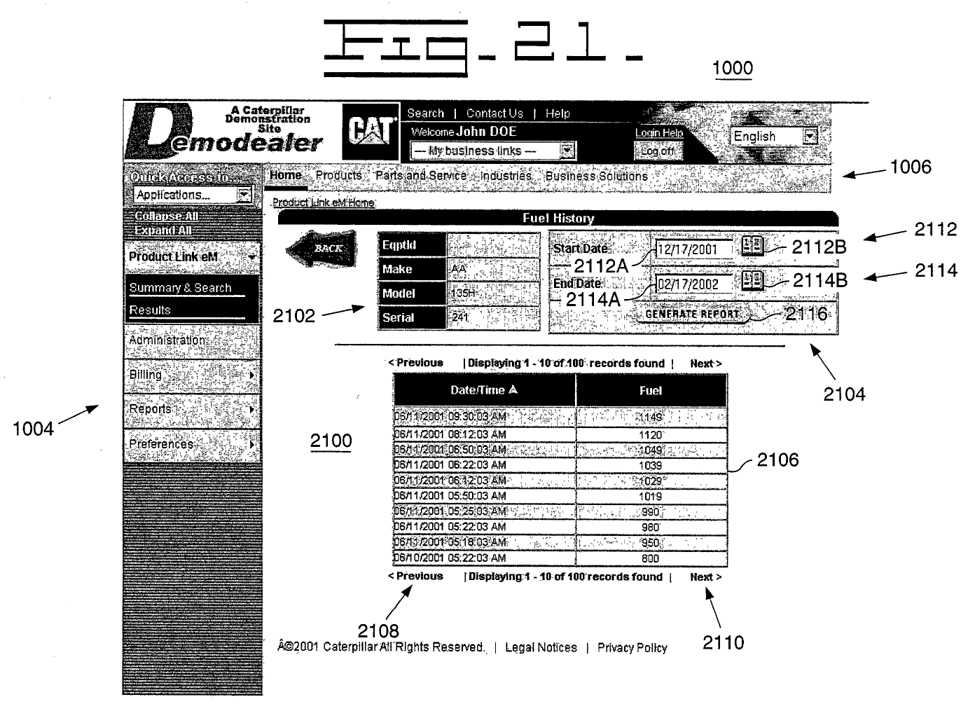

With reference to FIGS. 19-22, selection of the view service meter, fuel, and location option in the view drop down menu 1116, displays a service meter, fuel, and location screen 1900. The service meter, fuel and location screen 1900 includes a list of machines 1902. The list of machines 1902 includes a machine information section 1904 and a date/time, service meter units (SMU), fuel, and location section 1906. The list of machines 1902 includes a listing for each chosen machine (see above). The machine information section 1904 includes information related to each machine, including for example, equipment id, make, model and serial number. The date/time, SMU, fuel, and location section 1906 includes a service meter unit reading (service hours), a fuel usage value, and a last location. The date and time of these readings is also given. It should be noted that not all data for a given machine 102 in a user's group may have access to this information. For example, the machine may not be included in the machines to which the user 114 has subscribed. The list of machines 1902 may include more machines then are first listed. A previous link and a next link 1908, 1910 allow the user 114 to page through all of the machines 102.

The machine information section 1904 may also include a plurality of check boxes: one associated with each listing in the list of machines 1902 and a check box in the header of the list 1902. The machines 102 in the list 1902 may be individually selected or all may be selected by selecting the check box in the header. The service meter, fuel, and location screen 1900 also includes a map locations button 1914 which provides a map (not shown) with the location of each selected machine 102.

Each value in the date/time, SMU, fuel, and location section 1906 may be hyper-linked to a screen which adds additional information.

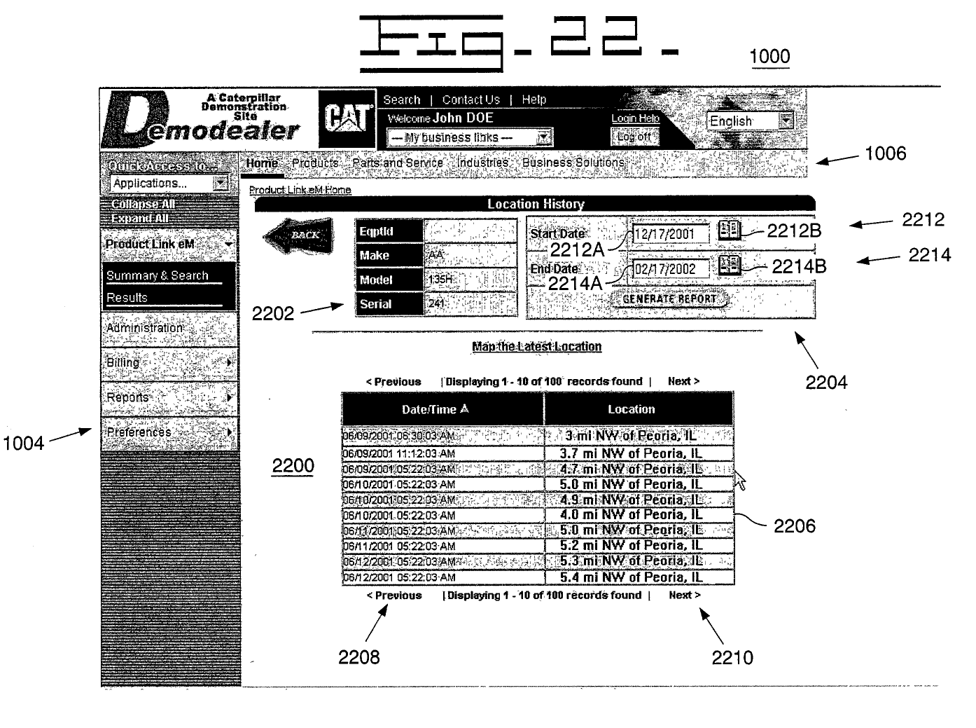

With particular reference to FIG. 20, selection of one of the SMU values in the date/time, SMU, fuel, and location section 1906 displays a SMU history screen 2000. The SMU history screen 2002 include a machine information section 2002, a report information section 2004, and a SMU list 2006. In the illustrated embodiment, the machine information section 2002 provides details regarding the current machine, such as, equipment id, make, model, and serial number. The SMU list 2006 lists the service hour readings and a date/time stamp for the current machine 102 over a given time period. The SMU list 2006 may be perused using a previous link 2008 and a next link 2010.

Initially, the covered time period is set to a default, but may be changed in the report information section 2004. The report information section 2004 includes a start date calendar 2012 and an end date calendar 2014. The start and end date calendars 2010, 2012 allow a date to be entered into a text box or 2012A, 2014A or entered using a calendar (not shown) accessed through a calendar button 2012B, 2014B. The report information section 2004 also includes a generate report button 2016 which refreshes the SMU list 2006 using the start and end dates entered in the report information section 2004.

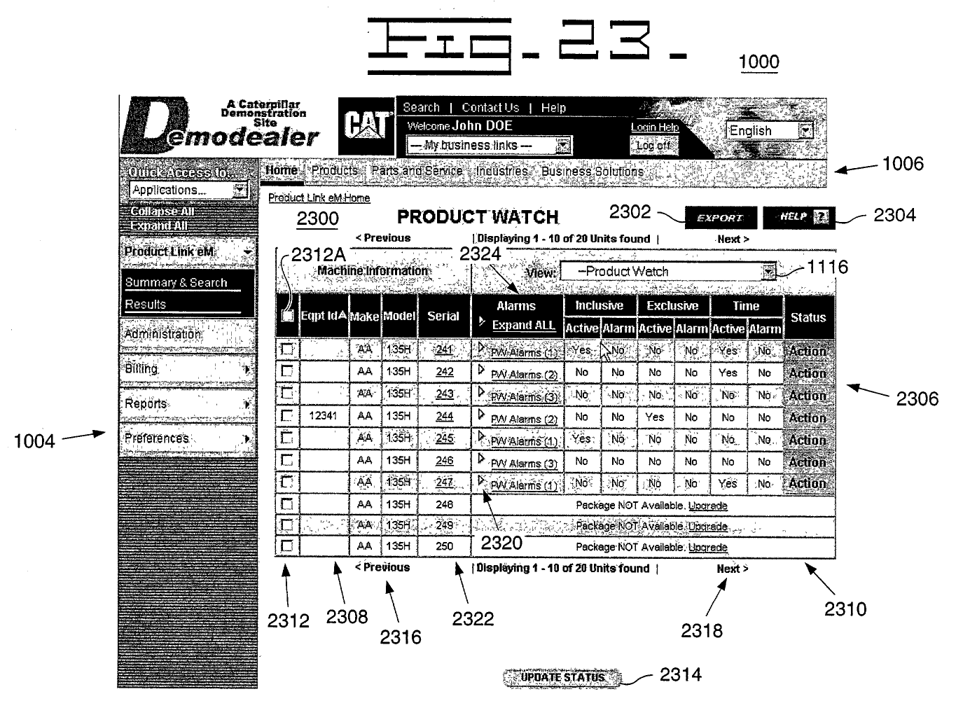

With particular reference to FIG. 21, selection of the one of the fuel values the date/time, SMU, fuel, and location section 1906 displays a fuel history screen 2100. The fuel history screen 2100 includes a machine information section 2102, a report information section 2104, and a fuel history list 2106. In the illustrated embodiment, the machine information section 2102 provides details regarding the current machine, such as, equipment id, make, model, and serial number. The fuel history list 2106 lists the fuel readings and a date/time stamp for the current machine 102 over a given time period. The fuel history list 2106 may be perused using a previous link 2108 and a next link 2110.

Initially, the covered time period is set to a default, but may be changed in the report information section 2104. The report information section 2104 includes a start date calendar 2112 and an end date calendar 2114. The start and end date calendars 2110, 2112 allow a date to be entered into a text box or 2112A, 2114A or entered using a calendar (not shown) accessed through a calendar button 2112B, 2114B. The report information section 2104 also includes a generate report button 2116 which refreshes the fuel list 2106 using the start and end dates entered in the report information section 2104.

With particular reference to FIG. 22, selection of the one of the location values the date/time, SMU, fuel, and location section 1906 displays a location history screen 2200. The location history screen 2200 includes a machine information section 2202, a report information section 2204, and a location list 2206. In the illustrated embodiment, the machine information section 2202 provides details regarding the current machine, such as, equipment id, make, model, and serial number. The location history list 2206 lists the location readings and a date/time stamp for the current machine 102 over a given time period. The location history list 2206 may be perused using a previous link 2208 and a next link 2210.

Initially, the covered time period is set to a default, but may be changed in the report information section 2204. The report information section 2204 includes a start date calendar 2212 and an end date calendar 2214. The start and end date calendars 2210, 2212 allow a date to be entered into a text box or 2212A, 2214A or entered using a calendar (not shown) accessed through a calendar button 2212B, 2214B. The report information section 2204 also includes a generate report button 2216 which refreshes the location list 2206 using the start and end dates entered in the report information section 2204.

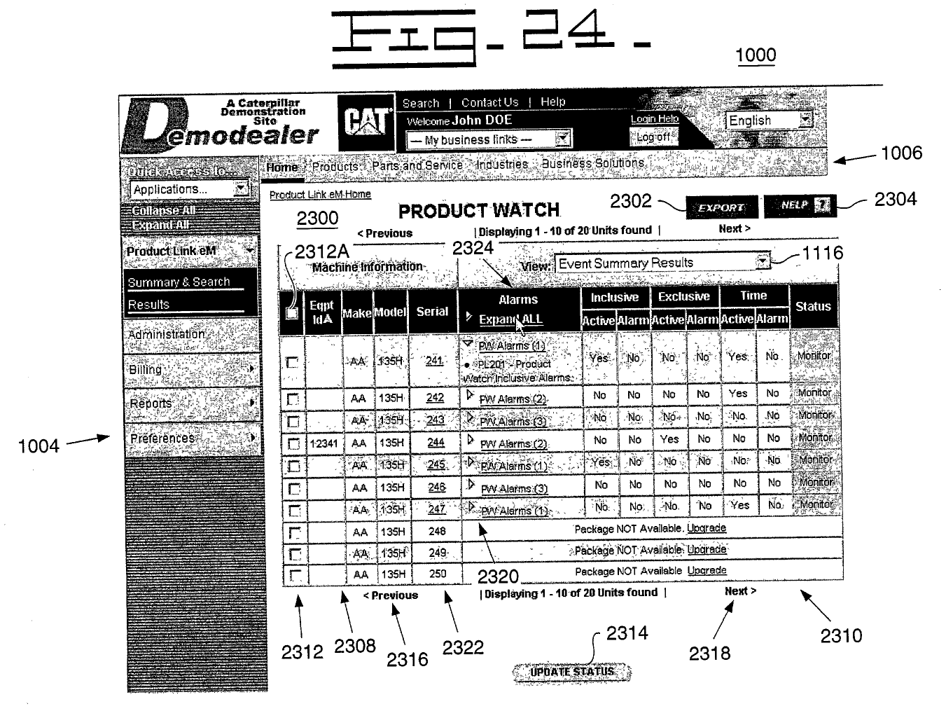

With reference to FIGS. 23-26, selection of the product watch option in the view drop down list 1116 displays a product watch screen 2300. The product watch screen 2300 details any alarms related to the time or location events for each machine 102 in the selected group. The product watch screen 2300 includes an export button 2302, a help button 2304, and a list machines 2306. The list of machines 2306 lists all product watch alarms for all machines 102 in the selected group and includes a machine information section 2308 and an alarm information section 2310. The machine information section 2208 provides details regarding the current machine, such as, equipment id, make, model, and serial number. The alarm information section 2310 provides details regarding the type of product alarms for each machine 102, i.e., whether the location or time alarms are defined and active for each machine 102 and the alarms status, e.g., Action, Monitor, or Normal.

The list of machines 106 includes a plurality of check boxes 2312 for each machine 102 and a check box 2312A in the header. The machines 102 may be individually selected using the check boxes 2312 or all of the machines 102 may be selected by using the check box 2312A in the header. Selection of an update status button 2314 updates the status of all alarms for the selected machines 102. The list of machines 106 may be perused using a previous link 2316 and a next link 2318.

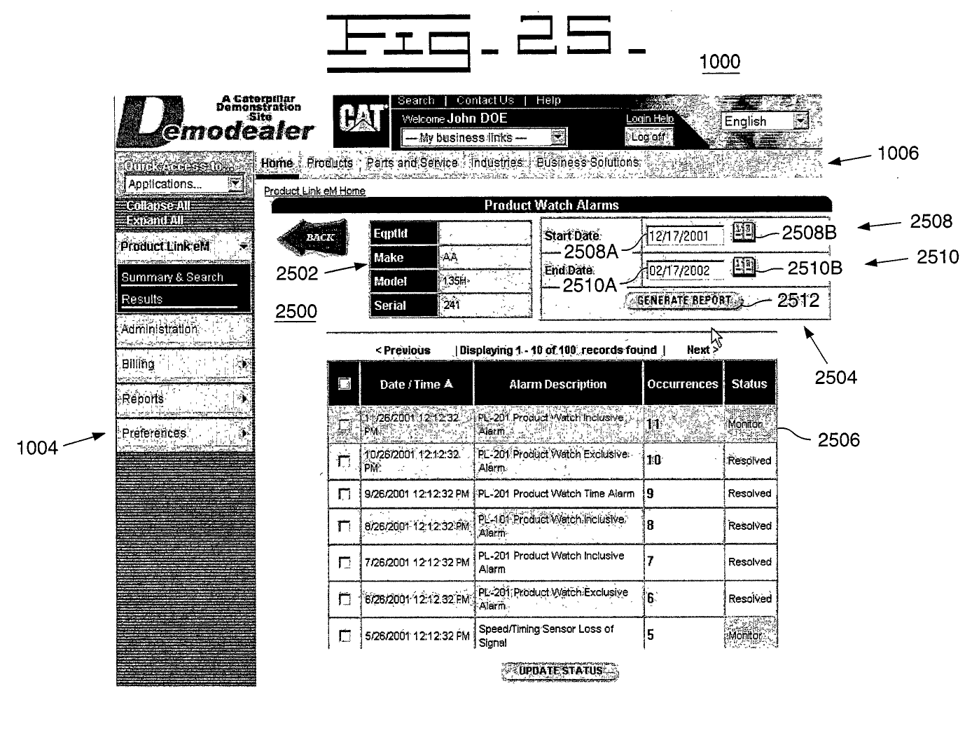

With reference to FIGS. 23 and 24, the alarm information section 2310 provides an arrow 2320 which expands each alarm to provide more details. All alarms may be expanded using an expand all link 2322.

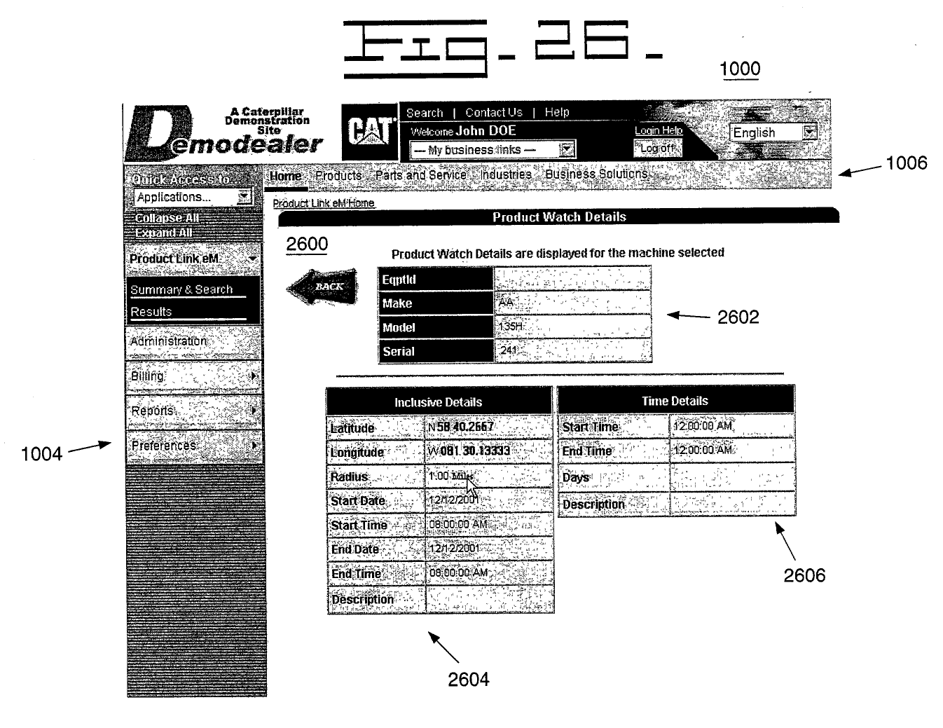

With reference to FIGS. 23 and 25, the machine information section 2308 provides a link 2324 for each machine 102 (for which data is available). Selection of the link 2324 for a particular machine 102 displays a product watch alarm screen 2500. The product watch alarm screen 2500 includes a machine information section 2502, a report information section 2504, and an alarm history list 2506. In the illustrated embodiment, the machine information section 2502 provides details regarding the current machine, such as, equipment id, make, model, and serial number. The alarm history list 2506 lists the alarms and a date/time stamp for the current machine 102 over a given time period. The location history list 2506 may be perused using a previous link and a next link (not shown).

Initially, the covered time period is set to a default, but may be changed in the report information section 2504. The report information section 2504 includes a start date calendar 2508 and an end date calendar 2510. The start and end date calendars 2508, 2510 allow a date to be entered into a text box or 2508A, 2510A or entered using a calendar (not shown) accessed through a calendar button 2508B, 2510B. The report information section 2504 also includes a generate report button 2512 which refreshes the location list 2506 using the start and end dates entered in the report information section 2504.

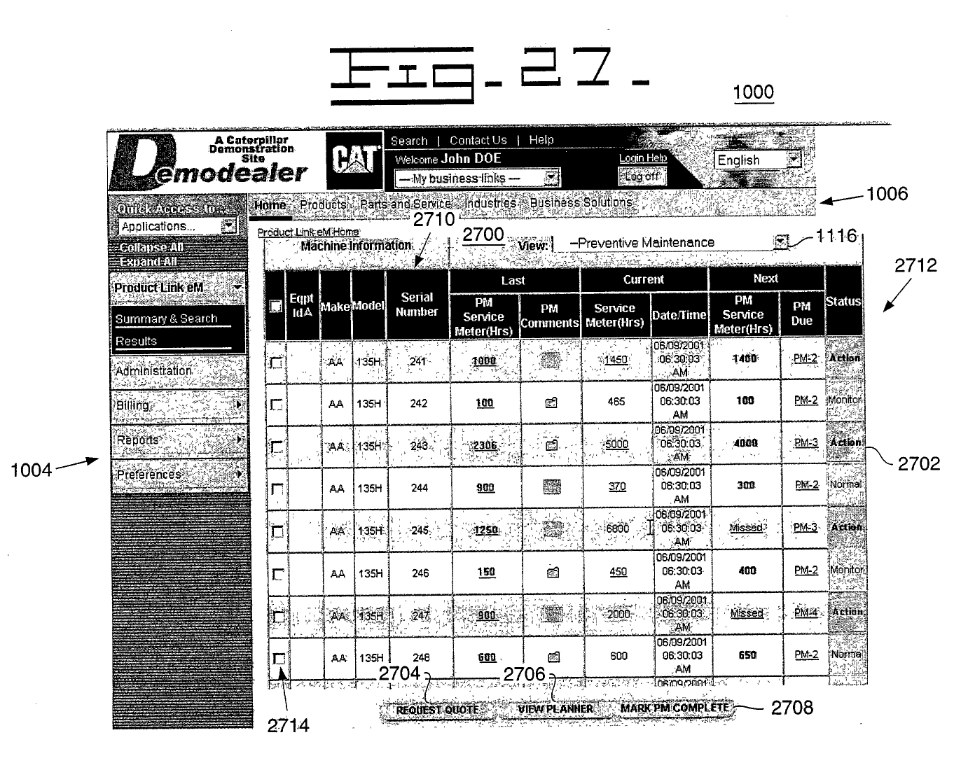

With reference to FIGS. 23 and 26, the alarm information section 2306 provides a link 2324 for each machine 102. Selection of a link 2324 displays a product watch details screen 2602. The product details screens includes a machine information section 2602, a geographic alarm information section 2604, and a time alarm details section 2606. The geographic alarm information section 2604 and the time alarm detail section 2606 provide the details for the respective geographic and time alarm for the machine 102 identified in the machine identification section 2602. As shown, for the current machine 102 an inclusive geographic alarm has been defined. In the illustrated embodiment, the geographic alarm is defined by a location (in latitude and longitude) and a radius. The alarm also is defined with a start date and time and an end date and time. Additionally, if the user 114 has the authority to modify the alarms, the alarms may be modified or defined in the details screen 2600.

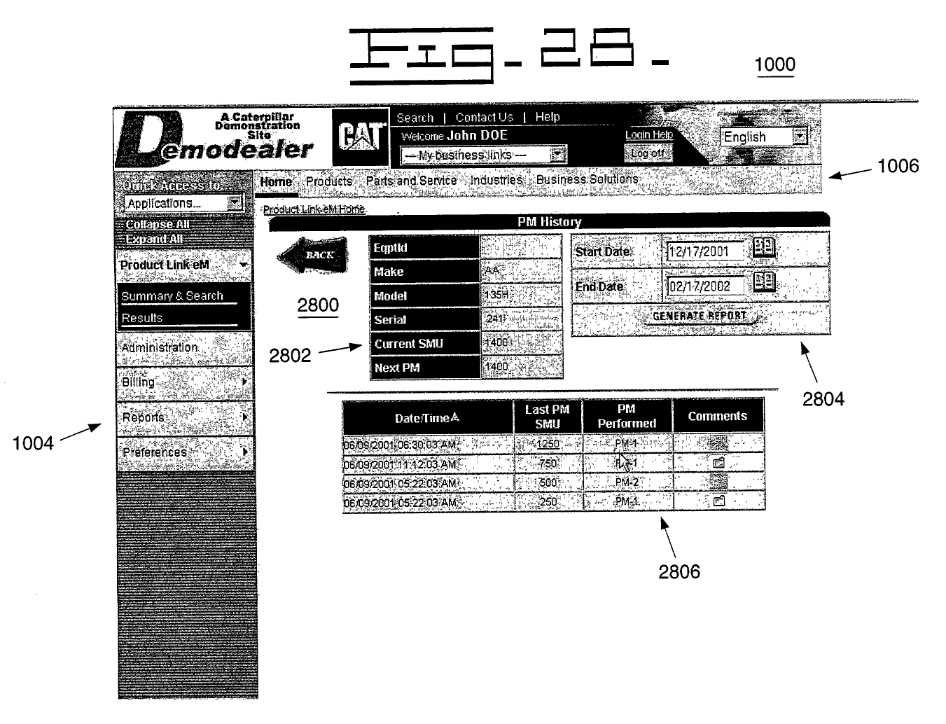

With reference to FIG. 27, selection of the preventative maintenance option on the view drop down list 1116 displays a preventative maintenance screen 2700. The preventative maintenance screen 2700 provides a preventative maintenance history for each machine 102 in the current group. In the illustrated embodiment, the preventative maintenance screen 2700 includes a list of machines 2702, a request quote button 2704, a view planner button 2706, and a mark PM complete button 2708.

The list of machines 2702 includes a machine information section 2710 and a maintenance section 2712. The machine information section 2710 provides information related to each machine, including for example, equipment id, make, model, and serial number. The machine information section 2710 also includes a plurality of check boxes 2714 for selecting machines 102.

The maintenance section 2712 provides details regarding the last, current and next preventative maintenance for each machine. In the illustrated embodiment, the maintenance section 2712 provides the information listed below.

last preventative maintenance:

service hours at which it was performed, and

comments

current preventative maintenance:

recommended service hours at which the preventative maintenance should be performed, and

current date and time.

next preventative maintenance:

service hours at which the service should be performed, and

the preventative maintenance which is next due.

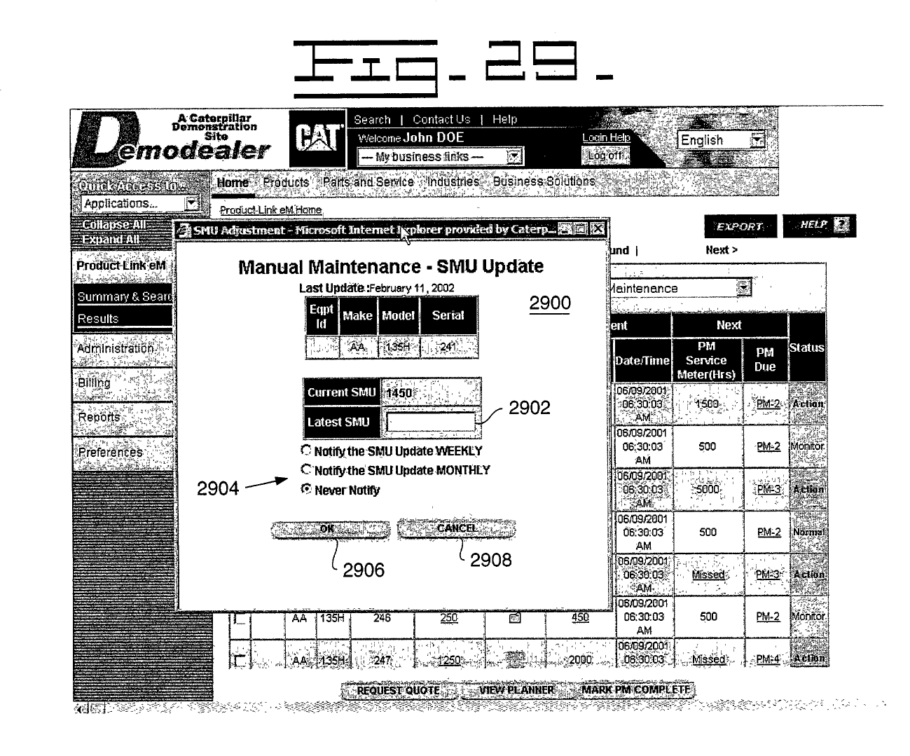

With reference to FIGS. 27 and 28, the service hours under the last preventative maintenance may be a hyper link. Selection of the hyperlink may display a preventative maintenance history screen 2800. The preventative maintenance history screen 2800 includes a machine information section 2802, a report information section 2804, and a preventative maintenance list 2806. The preventative maintenance history screen 2800 lists all preventative maintenance performed for the current machine in a given time period. The time period may be adjusted using the report information section 2802. Operation of the preventative maintenance screen 2800 is similar to the other screens discussed above, and is therefore, not further discussed.

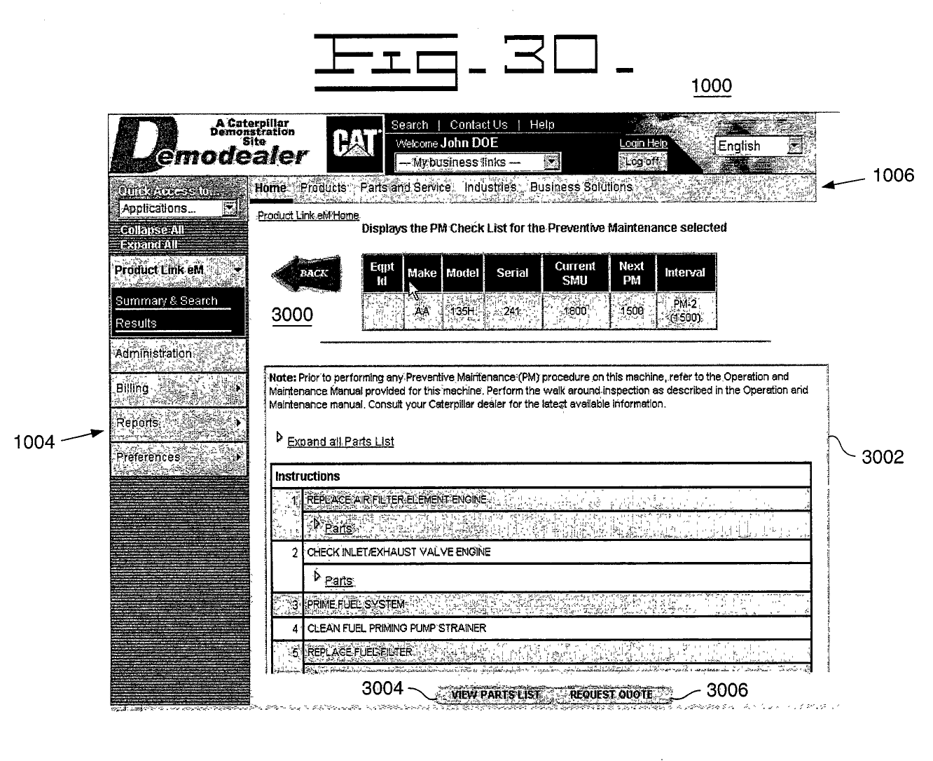

With reference to FIGS. 27 and 29, the service hours under current preventative maintenance may be a hyper link. Selection of this hyper link displays a SMU update dialog 2900. The SMU update dialog 2900 includes an entry box for updating the current actual service hours of a particular machine. As noted above, the service hours of some machines is updated automatically, or may require manual input. The SMU update dialog 2900 also includes a plurality of check boxes 2904 which allow the user 114 to specify when a notification to update service hours should be sent, e.g., weekly, monthly, or never.

The SMU update dialog 2900 also includes an OK button 2906 and a CANCEL button 2908 for respectively updating the service hours or closing the dialog 2900 without saving.

With reference to FIGS. 27 and 30-31, the preventative maintenance identified as being next may be a hyperlink, which when activated displays a preventative maintenance checklist screen 3000. The preventative maintenance checklist screen 3000 includes a list of instructions to perform the preventative maintenance. A link to a list of parts for each step may be provided. Or selection of a view parts list button 3004 displays a parts list 3100 for the selected step or all steps. The parts list 3100 may also include an order entry button 3102 for ordering the required parts.

Selection of the request quote button 2704 on the preventative maintenance screen 2700 or the request quote button 3004 on the preventative maintenance checklist screen 3000 may cause a signal, such as an email, to a dealer to request a quote from a dealer.

Selection of the view planner button 2706 displays a preventative maintenance (PM) dialog 3200 which includes a calendar 3202. The calendar 3202 allows the user 114 to schedule the preventative maintenance with the dealer, with an internal service shop, or for in-field maintenance.

Selection of the mark PM complete button 2708 displays a preventative maintenance (PM) completed dialog 3300. The PM completed dialog 3303 allows the user 114 to designate the selected PM(s) as having been completed. In the illustrated embodiment, the PM completed dialog 3300 allows the user to specify the service hours at which the PM was completed, the date, and to add comments. Alternatively, the system 100 may automatically sense that a PM has been completed (via an appropriate sensor located on the machine) and automatically designate that a PM has been completed.

Selection of the preventative maintenance option on the view drop down list 1116 displays a screen (not shown) containing a list of all maintenance performed on the machines 102 in the group. In one embodiment, the list identifies the machine, the date and time the maintenance was performed, the service hours at which the maintenance was performed, who performed the maintenance, and the machine down time. The list may also provide a hyper link for each machine in the select group, which when activated, displays a repair history screen (not shown) for the selected machine. The repair history screen displays a list of all maintenance performed on the machine during a preset period. The preset period may be modified by entry of new start and end dates.

Selection of the SOS option on the view drop down list 1116 displays a screen (not shown) containing a list of all scheduled oil samples (SOS) for the machines 102 in the current group. As discussed above, a hyperlink is provided for each SOS. Activation of the hyperlink displays a screen providing additional information or access to additional information regarding the SOS.

Selection of the fault codes option on the view drop down list 1116 displays a screen (not shown) containing a list of all fault codes received for the machines 102 in the current group. A link may also be provided which, when activated, displays another screen which lists all received codes for a selected machine during a given time period.

Selection of the machine performance option on the view drop down list 1116 provides access to reports on a machine utilization/performance. Performance is related to how the machine is performing, e.g., fuel usage, exhibited problems, potential problems, i.e.., through trending. Utilization refers to how much a machine is used versus how much a machine is not used. Other items that can be analyzed include how much time was the engine idling, fuel rate burning per hour, etc . . .

In another aspect of the present invention, the data stored in the repository 106 may be used to calculate operating costs in real-time, e.g., fuel and labor costs per hour, of a particular machine or a group of machines. Other costs which may be used to calculate operating costs include taxes, insurance, fuel operator associated costs, repair and maintenance costs (including cost for upcoming maintenance).

In still another aspect of the present invention, the data stored by the system 100 may be used to generate reports or otherwise support document/tracking compliance with governmental regulations.

In another aspect of the present invention, the system 100 may provide logistics support. For example, the system 100 may record location, weather, time or arrival, time of departure, etc . . . , for machines. Additionally, the system 100 may be linked to a camera system (not shown) which automatically takes pictures when machines enters or departs a location for various purposes, including inspection for wear and tear. The system 100 may forecast the consumption of consumables, such as fuel, and measure actual consumption. The system 100 may further by utilized to plan delivery of machines (when and where) and to dispatch operators and machines to various worksites or repair facilities.

Data may be used, e.g., from the particular machine or machines that are to be used or aggregate data from a plurality of machines based on type, model, job type, operating environment, climate, severity, etc . . . , to determine real-time costs. The real-time costs may then be input into a bidding calculator to assist the customer in preparing bids for contracts.

The data may also be used to productivity, efficiency, utilization, capacity, and/or performance of a machine or a plurality of machines. For example, for a particular machine, the number of work loads or operating cycles may be determined. In addition, the data may be used to determine the work cycle, i.e., how long was the work cycle or the parts of the work cycle, the material worked on, the site map. This information may be combined with the machine data to determine a more accurate representation of productivity, efficiency, utilization, capacity, and/or performance.

Utilization or underutilization of machines may be used (by owner) to determine fleet utilization and size. For example, if machines are under utilized, an owner's fleet may be too large or the owner has extra capacity to perform other jobs. Conversely, if the machines are over utilized, the owner may need to purchase or lease additional machines. The system 100 may also be adapted to perform “what if”scenarios, e.g., what would be the effect of adding additional machines to the fleet do to productivity, efficiency, utilization, capacity, and/or performance.

In still another aspect of the present invention, the system 100 may be used to identify and provide training, e.g., as virtual training. The system 100 may determined needed training based on the data stored and analysis of the data with respect to an operator or group of operators, .e.g., efficiency or productivity of an operator.

In still another aspect of the present invention, from the perspective of a manufacturer or a dealer, part usage for a fleet of machines may be trended. This may serve several purposes. For example, if part usage is higher or lower than expected, the severity of the application for which a machine may be modified (either increased severity or decreased severity). Or if part usage is lower than expected (from the dealer or manufacturer), but maintenance has been performed, then the owner of the machine is obtaining parts from an alternative source. The trend of part usage then represent lost sales opportunities.

In a further aspect of the present invention, system 100 may provide instant text and/or voice communication between users of the system 100 and/or operators of the machines 102. For example, a dispatcher located at a central location may communicate or broadcast to all operators or group of operators. Or operators may communicate with each other using assigned identifiers.

In one aspect of the present determines a severity of an application of one of the machines 102 as a function of the information. The severity of the application may be defined, in one embodiment, as high, medium or low.

In one aspect of the present invention, the fleet manager controller 110 trends inventory levels of at least one part used in response to the status information or the performance of a product maintenance recommendation to determine lost part sales opportunities.

In another aspect of the present invention, the fleet manager controller may determine an application of at least one of the machines 102 in response to the status information. For example, the application of the at least one of the machines 102 may be hauling material from point A to Point B. In one embodiment, the status information includes includes fuel usage and power ratings information. The status information may also include machine location information. In one embodiment, the application of the machine is a level of difficulty or severity. In a further embodiment, the fleet manager controller (110) may automatically modify the product maintenance schedule in response to the determined application of the at least one of the machines 102.

In another aspect of the present invention, the fleet manager controller 110 determines a productivity of one of the machines 102 in response to the status information. In one embodiment, the status information includes at least one of fuel usage, power ratings and machine location information.

In one aspect of the present invention, at least one of the machines automatically determines when a recommended action is performed.

In another aspect of the present invention, the fleet manager controller 110 provides machine operation recommendations to an operator of at least one of the machines 102 in response to the status information. In one embodiment, the status information includes at least one of fuel usage, power ratings, machine location, and terrain maps. fleet manager controller 110. For example, the machine operation recommendations may include a suggested route.

In one aspect of the present invention, the fleet manager controller 110 provides terrain modification recommendations in response to the status information, e.g., modification of a slope. In one embodiment, the status information includes at least one of fuel usage and power ratings. In another embodiment, the status information includes at least one of a machine application, a machine location, an existing terrain map.

In another aspect of the present invention, the fleet manager controller 110 determines productivity metrics for at least one of the machines 102. In one embodiment, the productivity metrics include where the at least one of the machines 102 operated. In another embodiment, the metrics include a material that was processed or hauled. In one embodiment, the fleet manager controller 110 displays a site map.

In one aspect of the present invention, the fleet manager controller 110 manages fleet operation in response to the status information.

In another aspect of the present invention, the fleet manager controller 110 determines utilization of at least one of the machines as a function of the status information. In one embodiment, the fleet manager controller 110 manages fleet operation in response to the determined utilization. In another embodiment, the fleet manager controller 110 analyzes fleet size in response to the determined utilization.

In one aspect of the present invention, the fleet manager controller 110 determines an operating cost associated with at least one of the machines 102. In one embodiment, the operating cost is determined as a function of a default operating cost associated with the at least one of the machines 102. In another embodiment, the operating cost is determined as a function of an operating enviromnent associated with the at least one of the machines 102. In still another embodiment, the operating cost is determined as a function of an application of the at least one of the machines 102. In one embodiment, the operating cost is determined as a function of at least one of a fuel usage, a maintenance cost, and a cost associated with machine downtime.

In another aspect of the present invention, the fleet manager controller 110 may determine a revenue associated with the at least one of the machines 102 as a function of the operating cost associated with the at least one of the machines 102. In one embodiment, the fleet manager controller 110 determines a productivity associated with the at least one of the machines 102 and the revenue associated with the at least one of the machines 102 is determined as a function of the productivity.

In one aspect of the present invention, the fleet manager controller 110 determines a bid for a project in response to the status information. In one embodiment, the fleet manager controller 110 determines an operating cost and the bid is determined as a function of the operating cost. In one embodiment, the operating cost is associated with the machines to be used in the project. In another embodiment, the operating cost is determined as a function of an environment associated with the project. In still another embodiment, the operating cost is determined as a function of a climate associated with the project. In a further embodiment, the operating cost is determined as a function of an application associated with the project.

In another aspect of the present invention, the fleet manager 110 determines a productivity and the bid is determined as a function of the productivity. In one embodiment, the productivity is associated with the machines 102 to be used in the project. In another embodiment, the productivity is determined as function of en environment associated with the project, e.g., the type of environment, such as a mining site. In another embodiment, the productivity is determined as a function of a climate associated with the project. In another embodiment, the productivity is determined as a function of an application associated with the project, e.g., hauling material, grading, etc . . .

In one aspect of the present invention, the fleet manager controller 110 determines a productivity associated with the machines 102 and determines a fleet of machines to be used on the project as a function of the productivity. In one embodiment, the bid is determined as a function of the fleet of machines. In another embodiment, the fleet manager controller 110 determines an operating cost associated with the fleet of machines 102 and the bid is determined as a function of the operating cost. In still another embodiment, the fleet manager controller 110 determines an estimate of machine availability based upon projected maintenance issues.

In another aspect of the present invention, the fleet manager controller 110 includes a simulator for receiving the status information for simulating work site activities and analyzes fleet size based on the simulation.

In one aspect of the present invention, the fleet manager controller 110 determines an operator efficiency based on the status information. In one embodiment, the status information includes at least one of an operating speed, a fuel usage, and machine movements.

In another aspect of the present invention, the fleet manager controller 110 visually notifies a user of upcoming invoice payments.

In one aspect of the present invention, the fleet manager controller 110 monitors weather conditions (through on-board sensors) and manages the machines 102 as a function of the weather conditions.

In another aspect of the present invention, the product maintenance recommendation includes at least one recommended action and the fleet manager controller 110 automatically determines when the at least one recommended action has been completed.

Industrial Applicability

With reference to the drawings, the present invention provides a system 100, computer program product 400, 500, 600, or method 700, 800, 900 for managing a plurality or fleet of machines 102. The present invention is applicable to any sort of machine or item for which data is available and for which it is desirable to track or monitor data.

In the illustrated embodiment, the system 100 is adapted to monitor mobile machines 102. The system 100 includes a communication conduit 104 for relaying status information back and forth between the system 100 and the machines 102. The system 100 stores the status information, historical data, and machine specification data in a repository. The system also includes a computer based fleet manager controller 110 which runs a fleet manager computer program or application 108. A fleet manager 112, which may be located at various locations, provide access to the system 100 to users 114.

As discussed above, the fleet manager 112 may be comprised of different pieces of software located at various locations, such as the manufacturer, a dealer, a customer support center and the customer.

Based on the location and the authority given to a particular user 114, the system 100 may have different functionality. For example, users 114 at the manufacturer may be provided tools which access the data in the repository 108 for purposes of supporting warranty claims. The users 114 at the customer may be provided with tools to plan, schedule, and/or order parts for a scheduled maintenance.

Other aspects, objects, and features of the present invention may be obtained from a study of the drawings, the disclosure, and the appended claims.

What is claimed is:

1. A fleet management system configured to manage a plurality of machines, comprising:
a communication conduit coupled to the machines for receiving status information related to the machines;
a repository coupled to the communication conduit for receiving and storing the status information, the repository containing historical and machine specification information; and
a fleet manager controller coupled to the repository for analyzing the status information as a function of the historical and machine specification information and responsively determining a product maintenance recommendation.

2. A fleet management system, as set forth in claim 1, wherein the fleet manager controller is further adapted to providing the product maintenance recommendation to a user.

3. A fleet management system, as set forth in claim 1, wherein the machine specification information includes a product maintenance schedule for each machine.

4. A fleet management system, as set forth in claim 3, wherein the product maintenance recommendation is a modification to the product maintenance schedule.

5. A fleet management system, as set forth in claim 3, wherein the production maintenance schedule is defined in terms of service hours.

6. A fleet management system, as set forth in claim 3, wherein the product maintenance schedule includes a plurality of scheduled maintenance steps, each step including at least one recommended action.

7. A fleet management system, as set forth in claim 3, wherein the product maintenance schedule includes at least a first maintenance step and a second maintenance step, the first maintenance step includes at least one recommended action and the second maintenance step includes the at least one recommended action and at least one other recommended action.

8. A fleet management system, as set forth in claim 7, wherein the first maintenance step is scheduled at X service hours and the second maintenance step is scheduled at X service hours, where Y>X.

9. A fleet management system, as set forth in claim 8, wherein the status information includes actual service hours.

10. A fleet management system, as set forth in claim 9, wherein the product maintenance recommendation for a specific machine is to perform the first maintenance step at X service hours if actual service hours is less than X service hours.

11. A fleet management system, as set forth in claim 10, wherein the product maintenance recommendation for the specific machine is to perform the first maintenance step if the first maintenance step has not been performed and actual service hours for the specific machine are less than (X+x), where (X+x) is less than Y.

12. A fleet management system, as set forth in claim 11, wherein the product maintenance recommendation is to perform the second maintenance step if the historical information indicates that the first maintenance step has not been performed and actual service hours for the specific machine are greater than (X+x).

13. A fleet management system, as set forth in claim 11, wherein x is equal to (Y−X)/2.

14. A fleet management system, as set forth in claim 3, wherein the fleet manager controller is adapted to modify the product maintenance schedule in response to input from a user.

15. A fleet management system, as set forth in claim 3, wherein the product maintenance schedule includes a plurality of scheduled maintenance steps, each step including at least one recommended action, and the fleet manager controller being adapted to modify the product maintenance schedule as a function of when a scheduled maintenance step was performed.

16. A fleet management system, as set forth in claim 8, wherein the service hours at which the second scheduled maintenance step is scheduled is modified as a function of an actual service hour at which the first scheduled maintenance step was performed.

17. A fleet management system, as set forth in claim 8, wherein Y is adjusted by N hours, if the first maintenance step was performed at X+N service hours.

18. A fleet management system, as set forth in claim 1, wherein the fleet manager controller is adapted to choose a subset of the plurality of machines as a function of input from a user.

19. A fleet management system, as set forth in claim 18, wherein the input is an identity of the user.

20. A fleet management system, as set forth in claim 1, wherein the fleet manager controller tracks at least one event for the plurality of machines.

21. A fleet management system, as set forth in claim 20, wherein the status information includes at least one parameter of the plurality of machines.

22. A fleet management system, as set forth in claim 21, wherein the at least one parameter is sensed by a sensor.

23. A fleet management system, as set forth in claim 21, wherein the at least one parameter is calculated.

24. A fleet management system, as set forth in claim 21, wherein the at least one event is defined by the at least one parameter with respect to a predefined value.

25. A fleet management system, as set forth in claim 24, wherein the event is defined as occurring when the parameter is above or below the predefined value.

26. A fleet management system, as set forth in claim 21, wherein the fleet manager controller being adapted to perform a trending analysis with respect to the parameter.

27. A fleet management system, as set forth in claim 4, wherein the status information includes fuel usage and the production maintenance schedule is defined in terms of fuel usage.

28. A fleet management system, as set forth in claim 20, wherein the status information includes one of a fault code, a scheduled oil sampling, a preventative maintenance, and a service meter update.

29. A fleet management system, as set forth in claim 20, wherein the fleet manager controller assigns a status code to each event.

30. A fleet management system, as set forth in claim 29, wherein the status code is one of normal, action, and monitor.

31. A fleet management system, as set forth in claim 1, wherein the status information includes service meter hours, fuel, and location.

32. A fleet management system, as set forth in claim 20, wherein the event is related to one of location and time.

33. A fleet management system, as set forth in claim 32, wherein the fleet manager controller is adapted to allow a user to define the at least one event related to the one of location and time.

34. A fleet management system, as set forth in claim 32, wherein the event is one of inclusive and exclusive.

35. A fleet management system, as set forth in claim 1, wherein the product maintenance recommendation includes at least one recommended maintenance step.

36. A fleet management system, as set forth in claim 35, wherein the fleet manager controller is adapted to allow a user to request a quote related to the recommended maintenance step.

37. A fleet management system, as set forth in claim 35, wherein the fleet manager controller is adapted to schedule the at least one recommended maintenance step.

38. A fleet management system, as set forth in claim 35, wherein the at least one recommended maintenance step is performed by another party.

39. A fleet management system, as set forth in claim 35, wherein the fleet manager controller is adapted to allow a user to mark the at least one recommended maintenance step as completed.

40. A fleet management system, as set forth in claim 35, wherein the fleet manager controller displays a list of parts required for the at least one recommended maintenance step.

41. A fleet management system, as set forth in claim 40, wherein the fleet manager controller orders the parts.

42. A fleet management system, as set forth in claim 1, wherein the fleet manager controller is adapted to analyze a utilization of the machine in response to input from a user.

43. A fleet management system, as set forth in claim 1, wherein the fleet manager controller is adapted to analyze a performance of a machine as a function of the historical data.

44. A fleet management system, as set forth in claim 1, wherein the fleet manager controller determines a severity of an application of one of the machines as a function of the status information.

45. A fleet management system, as set forth in claim 44, wherein the fleet manager controller trends inventory levels of at least one part used in performing the product maintenance recommendation to determine lost part sales opportunities.

46. A fleet management system, as set forth in claim 1, wherein the fleet manager controller trends inventory levels of at least one part used in response to the status information to determine lost sales opportunities.

47. A fleet management system, as set forth in claim 1, wherein the fleet manager controller automatically schedules equipment transportation as required in response to the status information.

48. A fleet management system, as set forth in claim 47, wherein the equipment transportation includes sending a service truck to one or more of the machines.

49. A fleet management system, as set forth in claim 47, wherein the equipment transportation is transportation to relocate one or more of the machines to a maintenance facility.

50. A fleet management system, as set forth in claim 1, wherein the fleet manager controller determines an application of at least one of the machines in response to the status information.

51. A fleet management system, as set forth in claim 50, wherein the status information includes fuel usage and power ratings information.

52. A fleet management system, as set forth in claim 50, wherein the status information includes at least one of fuel usage, power ratings and machine location information.

53. A fleet management system, as set forth in claim 50, wherein the application of machine is a level of difficulty.

54. A fleet management system, as set forth in claim 50, wherein the machine specification information includes a product maintenance schedule for the least one of the machines and the fleet manager controller automatically modifies the product maintenance schedule in response to the determined application of the at least one of the machines.

55. A fleet management system, as set forth in claim 1, wherein the fleet manager controller determines a productivity of one of the machines in response to the status information.

56. A fleet management system, as set forth in claim 54, wherein the status information includes at least one of fuel usage, power ratings and machine location information.

57. A fleet management system, as set forth in claim 1, wherein the product maintenance recommendation includes at least one recommended action and wherein at least one of the machines automatically determines when the at least one recommended action is performed.

58. A fleet management system, as set forth in claim 1, wherein the fleet manager controller provides machine operation recommendations to an operator of at least one of the machines in response to the status information.

59. A fleet management system, as set forth in claim 58, wherein the status information includes at least one of fuel usage, power ratings, machine location, and terrain maps.

60. A fleet management system, as set forth in claim 1, wherein the fleet manager controller provides terrain modification recommendations in response to the status information.

61. A fleet management system, as set forth in claim 60, wherein the status information includes at least one of fuel usage and power ratings.

62. A fleet management system, as set forth in claim 61, wherein the status information includes at least one of a machine application, a machine location, an existing terrain map.

63. A fleet management system, as set forth in claim 1, wherein the fleet manager controller determines productivity metrics for at least one of the machines.

64. A fleet management system, as set forth in claim 63, wherein the productivity metrics include where the at least one of the machines operated.

65. A fleet management system, as set forth in claim 63, wherein the productivity metrics include a material that was processed.

66. A fleet management system, as set forth in claim 63, wherein the fleet manager controller displays a site map.

67. A fleet management system, as set forth in claim 1, wherein the fleet manager controller manages fleet operation in response to the status information.

68. A fleet management system, as set forth in claim 1, wherein the fleet manager controller determines utilization of at least one of the machines as a function of the status information.

69. A fleet management system, as set forth in claim 68, wherein the fleet manager controller manages fleet operation in response to the determined utilization.

70. A fleet management system, as set forth in claim 68, wherein the fleet manager controller analyzes fleet size in response to the determined utilization.

71. A fleet management system, as set forth in claim 1, wherein the fleet manager controller determines an operating cost associated with at least one of the machines.

72. A fleet management system, as set forth in claim 71, wherein the operating cost is determined as a function of a default operating cost associated with the at least one of the machines.

73. A fleet management system, as set forth in claim 71, wherein the operating cost is determined as a function of an operating environment associated with the at least one of the machines.

74. A fleet management system, as set forth in claim 71, wherein the operating cost is determined as a function of an application of the at least one of the machines.

75. A fleet management system, as set forth in claim 71, wherein the operating cost is determined as a function of at least one of a fuel usage, a maintenance cost, and a cost associated with machine downtime.

76. A fleet management system, as set forth in claim 71, wherein the fleet manager controller determines a revenue associated with the at least one of the machines as a function of the operating cost associated with the at least one of the machines.

77. A fleet management system, as set forth in claim 76, wherein the fleet manager controller determines a productivity associated with the at least one of the machines and the revenue associated with the at least one of the machines is determined as a function of the productivity.

78. A fleet management system, as set forth in claim 1, wherein the fleet manager controller determines a bid for a project in response to the status information.

79. A fleet management system, as set forth in claim 78, wherein the fleet manager controller determines an operating cost and the bid is determined as a function of the operating cost.

80. A fleet management system, as set forth in claim 79, wherein the operating cost is associated with the machines to be used in the project.

81. A fleet management system, as set forth in claim 79, wherein the operating cost is determined as a function of an environment associated with the project.

82. A fleet management system, as set forth in claim 79, wherein the operating cost is determined as a function of a climate associated with the project.

83. A fleet management system, as set forth in claim 79, wherein the operating cost is determined as a function of an application associated with the project.

84. A fleet management system, as set forth in claim 78, wherein the fleet manager determines a productivity and the bid is determined as a function of the productivity.

85. A fleet management system, as set forth in claim 84, wherein the productivity is associated with the machines to be used in the project.

86. A fleet management system, as set forth in claim 84, wherein the productivity is determined as function of en environment associated with the project.

87. A fleet management system, as set forth in claim 84, wherein the productivity is determined as a function of a climate associated with the project.

88. A fleet management system, as set forth in claim 84, wherein the productivity is determined as a function of an application associated with the project.

89. A fleet management system, as set forth in claim 78, wherein the fleet manager controller determines a productivity associated with the machines and determines a fleet of machines to be used on the project as a function of the productivity.

90. A fleet management system, as set forth in claim 89, wherein the bid is determined as a function of the fleet of machines.

91. A fleet management system, as set forth in claim 90, wherein the fleet manager controller determines an operating cost associated with the fleet of machines and the bid is determined as a function of the operating cost.

92. A fleet management system, as set forth in claim 91, wherein the fleet manager controller determines an estimate of machine availability based upon projected maintenance issues.

93. A fleet management system, as set forth in claim 1, wherein the fleet manager controller includes a simulator for receiving the status information for simulating work site activities, the fleet manager controller being adapted to analyze fleet size based on the simulation.

94. A fleet management system, as set forth in claim 1, wherein the fleet manager allows text messaging between multiple machines.

95. A fleet management system, as set forth in claim 1, wherein the fleet manager controller determines an operator efficiency based on the status information.

96. A fleet management system, as set forth in claim 95, wherein the status information includes at least one of an operating speed, a fuel usage, and machine movements.

97. A fleet management system, as set forth in claim 1, wherein the fleet manager controller visually notifies a user of upcoming invoice payments.

98. A fleet management system, as set forth in claim 1, wherein the fleet manager controller monitors weather conditions and manages the machines as a function of the weather conditions.

99. A fleet management system, as set forth in claim 1, wherein the product maintenance recommendation includes at least one recommended action and wherein the fleet manager controller automatically determines when the at least one recommended action has been completed.

100. A fleet management system for managing a plurality of machines, comprising:
a communication conduit coupled to the machines for receiving status information related to the machines;
a repository coupled to the communication conduit for receiving and storing the status information, the repository containing historical and machine specification information, the machine specification information including a product maintenance schedule for each machine; and,
a fleet manager controller coupled to the repository for analyzing the status information as a function of the historical and machine specification information and responsively modify the product maintenance schedule.

101. A fleet management system, as set forth in claim 101, wherein the production maintenance schedule is defined in terms of service hours.

102. A fleet management system, as set forth in claim 101, wherein the product maintenance schedule includes a plurality of scheduled maintenance steps, each step including at least one recommended action.

103. A fleet management system, as set forth in claim 101, wherein the product maintenance schedule includes at least a first maintenance step and a second maintenance step, the first maintenance step includes at least one recommended action and the second maintenance step includes the at least one recommended action and at least one other recommended action.

104. A fleet management system, as set forth in claim 103, wherein the first maintenance step is scheduled at X service hours and the second maintenance step is scheduled at X service hours, where Y>X.

105. A fleet management system, as set forth in claim 104, wherein the status information includes actual service hours.

106. A fleet management system, as set forth in claim 105, wherein the product maintenance recommendation for a specific machine (102) is to perform the first maintenance step at X service hours if actual service hours is less than X service hours.

107. A fleet management system, as set forth in claim 106, wherein the product maintenance recommendation for the specific machine is to perform the first maintenance step if the historical information indicates that the first maintenance step has not been performed and actual service hours for the specific machine are less than (X+x), where (X+x) is less than Y.

108. A fleet management system, as set forth in claim 107, wherein the product maintenance recommendation is to perform the second maintenance step if the first maintenance step has not been performed and actual service hours for the specific machine are greater than (X+x).

109. A fleet management system, as set forth in claim 107, wherein x is equal to (Y-X)/2.

110. A fleet management system, as set forth in claim 101, wherein the fleet manager controller is adapted to modify the product maintenance schedule in response to input from a user.

111. A fleet management system, as set forth in claim 101, wherein the product maintenance schedule includes a plurality of scheduled maintenance steps, each step including at least one recommended action, and the fleet manager controller being adapted to modify the product maintenance schedule as a function of when a schedule maintenance step was performed.

112. A fleet management system, as set forth in claim 103, wherein the service hours at which the second scheduled maintenance step is scheduled is modified as a function of an actual service hour at which the first scheduled maintenance step was performed.

113. A fleet management system, as set forth in claim 112, wherein Y is adjusted by N hours, if the first maintenance step was performed at X+N service hours.

114. A fleet management system for managing a plurality of machines, comprising:
a communication conduit coupled to the machines for receiving status information related to the machines;
a repository coupled to the communication conduit for receiving and storing the status information, the repository containing historical and machine specification information; and,
a fleet manager controller analyzing the status information as a function of the historical and machine specification information and tracking at least one event for the plurality of machines, the event being related to one of location and time.

115. A fleet management system, as set forth in claim 114, wherein the fleet manager controller is adapted to allow a user to define the at least one event related to the one of location and time.

116. A fleet management system, as set forth in claim 115, wherein the event is one of inclusive and exclusive.

117. A computer program product for managing a plurality of machines, comprising:
computer readable program code means for receiving status information related to the machines;
computer readable program code means for receiving and storing the status information in a repository, the repository containing historical and machine specification information; and,
computer readable program code means for analyzing the status information as a function of the historical and machine specification information and responsively determining a product maintenance recommendation.

118. A computer program product for managing a plurality of machines, comprising:
computer readable program code means for receiving status information related to the machines;
computer readable program code means for receiving and storing the status information in a repository, the repository containing historical and machine specification information, the machine specification information including a product maintenance schedule for each machine; and,
computer readable program code means for analyzing the status information as a function of the historical and machine specification information and responsively modifying the product maintenance schedule.

119. A computer program product for managing a plurality of machines, comprising:
computer readable program code means for receiving status information related to the machines;
computer readable program code means for receiving and storing the status information in a repository, the repository containing historical and machine specification information; and,
computer readable program code means for analyzing the status information as a function of the historical and machine specification information and tracking at least one event for the plurality of machines, the event being related to one of location and time.

120. A method for managing a plurality of machines, including the steps of:
establishing status information related to the machines;
receiving and storing the status information at a repository, the repository containing historical and machine specification information; and,
analyzing the status information as a function of the historical and machine specification information and responsively determining a product maintenance recommendation.

121. A method, as set forth in claim 120, including the step of providing the product maintenance recommendation to a user.

122. A method, as set forth in claim 120, wherein the machine specification information includes a product maintenance schedule for each machine.

123. A method, as set forth in claim 122, wherein the product maintenance recommendation is a modification to the product maintenance schedule.

124. A method, as set forth in claim 122, wherein the production maintenance schedule is defined in terms of service hours.

125. A method, as set forth in claim 122, wherein the product maintenance schedule includes a plurality of scheduled maintenance steps, each scheduled maintenance step including at least one recommended action.

126. A method, as set forth in claim 122, wherein the product maintenance schedule includes at least a first maintenance step and a second maintenance step, the first maintenance step includes at least one recommended action and the second maintenance step includes the at least one recommended action and at least one other recommended action.

127. A method, as set forth in claim 126, wherein the first maintenance step is scheduled at X service hours and the second maintenance step is scheduled at Y service hours, where Y>X.

128. A method, as set forth in claim 127, wherein the status information includes actual service hours.

129. A method, as set forth in claim 128, wherein the product maintenance recommendation for a specific machine is to perform the first maintenance step at X service hours if actual service hours is less than X service hours.

130. A method, as set forth in claim 129, wherein the product maintenance recommendation for the specific machine is to perform the first maintenance step if the first maintenance step has not been performed and actual service hours for the specific machine are less than (X+x), where (X+x) is less than Y.

131. A method, as set forth in claim 130, wherein the product maintenance recommendation is to perform the second maintenance step if the first maintenance step has not been performed and actual service hours for the specific machine are greater than (X+x).

132. A method, as set forth in claim 130, wherein x is equal to (Y−X)/2.

133. A method, as set forth in claim 122, including the step of modifying the product maintenance schedule in response to input from a user.

134. A method, as set forth in claim 122, wherein the product maintenance schedule includes a plurality of scheduled maintenance steps, each step including at least one recommended action, and the method includes the step of modifying the product maintenance schedule as a function of when a scheduled maintenance step was performed.

135. A method, as set forth in claim 127, including the step of modifying the service hour at which the second scheduled maintenance step is scheduled as a function of an actual service hour at which the first scheduled maintenance step was performed.

136. A method, as set forth in claim 127, wherein Y is adjusted by N hours, if the first maintenance step was performed at X+N service hours.

137. A method, as set forth in claim 120, including the step choosing a subset of the plurality of machines as a function of input from a user.

138. A method, as set forth in claim 137, wherein the input is an identity of the user.

139. A method, as set forth in claim 120, including the step of tracking at least one event for the plurality of machines.

140. A method, as set forth in claim 139, wherein the status information includes at least one parameter of the plurality of machines.

141. A method, as set forth in claim 140, wherein the at least one parameter is sensed by a sensor.

142. A method, as set forth in claim 140, wherein the at least one parameter is calculated.

143. A method, as set forth in claim 140, wherein the at least one event is defined by the at least one parameter with respect to a predefined value.

144. A method, as set forth in claim 143, wherein the event is defined as occurring when the parameter is above or below the predefined value.

145. A method, as set forth in claim 140, including the step of performing a trending analysis with respect to the parameter.

146. A method, as set forth in claim 120, wherein the status information includes fuel usage and the production maintenance schedule is defined in terms of fuel usage.

147. A method, as set forth in claim 139, wherein the status information includes one of a fault code, a scheduled oil sampling, a preventative maintenance, and a service meter update.

148. A method, as set forth in claim 139, including the step of assigning a status code to each event.

149. A method, as set forth in claim 148, wherein the status code is one of normal, action, and monitor.

150. A method, as set forth in claim 120, wherein the status information includes service meter hours, fuel, and location.

151. A method, as set forth in claim 139, wherein the event is related to one of location and time.

152. A method, as set forth in claim 151, including the step of the defining, by a user, the at least one event related to the one of location and time.

153. A method, as set forth in claim 151, wherein the event is one of inclusive and exclusive.

154. A method, as set forth in claim 120, wherein the product maintenance recommendation includes at least one recommended maintenance step.

155. A method, as set forth in claim 154, including the step of requesting, by a user, a quote related to the recommended maintenance step.

156. A method, as set forth in claim 154, including the step of scheduling, by a user, the at least one recommended maintenance step.

157. A method, as set forth in claim 154, wherein the at least one recommended maintenance step is performed by another party.

158. A method, as set forth in claim 154, including the step of marking, by a user, the at least one recommended maintenance step as completed.

159. A method, as set forth in claim 154, including the step of displaying a list of parts required for the at least one recommended maintenance step.

160. A method, as set forth in claim 159, including the step of ordering, by a user, the parts.

161. A method, as set forth in claim 159, including the step of automatically ordering the parts.

162. A method, as set forth in claim 161, wherein the step of automatically ordering the parts includes the steps of:
reviewing a parts inventory of the parts; and
ordering the parts if the inventory drops below a predetermined threshold.

163. A method, as set forth in claim 120, including the step of analyzing a utilization of the machine as a function of the historical data.

164. A method, as set forth in claim 120, including the step of analyzing a performance of a machine as a function of the historical data.

165. A method, as set forth in claim 120, including the step of determining a severity of an application of one of the machines as a function of the status information.

166. A method, as set forth in claim 165, including the step of trending inventory levels of at least one part used in performing the product maintenance recommendation to determine lost part sales opportunities.

167. A method, as set forth in claim 120, including the step of trending inventory levels of at least one part used in response to the status information to determine lost sales opportunities.

168. A method, as set forth in claim 120, including the step of automatically scheduling equipment transportation as required in response to the status information.

169. A method, as set forth in claim 168, wherein the equipment transportation includes sending a service truck to one or more of the machines.

170. A method, as set forth in claim 168, wherein the equipment transportation is a transportation to relocate one or more of the machines to a maintenance facility.

171. A method, as set forth in claim 120, including the step of determining an application of at least one of the machines in response to the status information.

172. A method, as set forth in claim 171, wherein the status information includes fuel usage and power ratings information.

173. A method, as set forth in claim 171, wherein the status information includes at least one of fuel usage, power ratings and machine location information.

174. A method, as set forth in claim 171, wherein the application of machine is a level of difficulty.

175. A method, as set forth in claim 171, wherein the machine specification information includes a product maintenance schedule for the least one of the machines and the method includes the step of automatically modifying the product maintenance schedule in response to the determined application of the at least one of the machines.

176. A method, as set forth in claim 120, including the step determining a productivity of one of the machines in response to the status information.

177. A method, as set forth in claim 176, wherein the status information includes at least one of fuel usage, power ratings and machine location information.

178. A method, as set forth in claim 120, wherein the product maintenance recommendation includes at least one recommended action and the method includes the step of automatically determining, by the at least one of the machines, when the at least one recommended action is performed.

179. A method, as set forth in claim 120, including the step of providing machine operation recommendations to an operator of at least one of the machines in response to the status information.

180. A method, as set forth in claim 179, wherein the status information includes at least one of fuel usage, power ratings, machine location, and terrain maps. fleet manager controller.

181. A method, as set forth in claim 120, including the step of providing terrain modification recommendations in response to the status information.

182. A method, as set forth in claim 181 wherein the status information includes at least one of fuel usage and power ratings.

183. A method, as set forth in claim 181, wherein the status information includes at least one of a machine application, a machine location, an existing terrain map.

184. A method, as set forth in claim 120, including the step of determining productivity metrics for at least one of the machines.

185. A method (700), as set forth in claim 184, wherein the productivity metrics include where the at least one of the machines operated.

186. A method, as set forth in claim 184, wherein the productivity metrics include a material that was processed.

187. A method, as set forth in claim 184, including the step of displaying a site map.

188. A method, as set forth in claim 120, wherein including the step of managing fleet operation in response to the status information.

189. A method, as set forth in claim 120, including the step of determining utilization of at least one of the machines as a function of the status information.

190. A method, as set forth in claim 189, including the step of managing fleet operation in response to the determined utilization.

191. A method, as set forth in claim 189, including the step of analyzing fleet size in response to the determined utilization.

192. A method, as set forth in claim 64, including the step of determining an operating cost associated with at least one of the machines.

193. A method, as set forth in claim 192, wherein the operating cost is determined as a function of a default operating cost associated with the at least one of the machines.

194. A method, as set forth in claim 192, wherein the operating cost is determined as a function of an operating environment associated with the at least one of the machines.

195. A method, as set forth in claim 192, wherein the operating cost is determined as a function of an application of the at least one of the machines.

196. A method, as set forth in claim 192, wherein the operating cost is determined as a function of at least one of a fuel usage, a maintenance cost, and a cost associated with machine downtime.

197. A method, as set forth in claim 192, including the step of determining a revenue associated with the at least one of the machines as a function of the operating cost associated with the at least one of the machines.

198. A method, as set forth in claim 197, including the step of determining a productivity associated with the at least one of the machines and the revenue associated with the at least one of the machines is determined as a function of the productivity.

199. A method, as set forth in claim 120, including the step of determining a bid for a project in response to the status information.

200. A method, as set forth in claim 199, including the step of determining an operating cost and the bid is determined as a function of the operating cost.

201. A method, as set forth in claim 200, wherein the operating cost is associated with the machines to be used in the project.

202. A method, as set forth in claim 200, wherein the operating cost is determined as a function of an environment associated with the project.

203. A method, as set forth in claim 200, wherein the operating cost is determined as a function of a climate associated with the project.

204. A method, as set forth in claim 200, wherein the operating cost is determined as a function of an application associated with the project.

205. A method, as set forth in claim 199, including the step of determining a productivity, wherein the bid is determined as a function of the productivity.

206. A method, as set forth in claim 205, wherein the productivity is associated with the machines to be used in the project.

207. A method, as set forth in claim 205, wherein the productivity is determined as function of en environment associated with the project.

208. A method, as set forth in claim 205, wherein the productivity is determined as a function of a climate associated with the project.

209. A method, as set forth in claim 205, wherein the productivity is determined as a function of an application associated with the project.

210. A method, as set forth in claim 199, including the step of determining a productivity associated with the machines and determines a fleet of machines to be used on the project as a function of the productivity.

211. A method, as set forth in claim 210, wherein the bid is determined as a function of the fleet of machines.

212. A method, as set forth in claim 211, including the step of determining an operating cost associated with the fleet of machines and the bid is determined as a function of the operating cost.

213. A method, as set forth in claim 212, including the step of determining an estimate of machine availability based upon projected maintenance issues.

214. A method, as set forth in claim 120, including the steps of simulating work site activities and analyzing fleet size based on the simulation.

215. A method, as set forth in claim 120, including the step of providing text messaging between multiple machines.

216. A method, as set forth in claim 120, including the step of determining an operator efficiency based on the status information.

217. A method, as set forth in claim 216, wherein the status information includes at least one of an operating speed, a fuel usage, and machine movements.

218. A method, as set forth in claim 120, including the step of visually notifying a user of upcoming invoice payments.

219. A method, as set forth in claim 120, including the steps of monitoring weather conditions and managing the machines as a function of the weather conditions.

220. A method, as set forth in claim 120, wherein the product maintenance recommendation includes at least one recommended action and the method includes the step automatically determining when the at least one recommended action has been completed.

221. A method for managing a plurality of machines, including the steps of:
establishing status information related to the machines;
receiving and storing the status information in a repository, the repository containing historical and machine specification information, the machine specification information including a product maintenance schedule for each machine; and,
analyzing the status information as a function of the historical and machine specification information and responsively modifying the product maintenance schedule.

222. A method, as set forth in claim 221, wherein the production maintenance schedule is defined in terms of service hours.

223. A method, as set forth in claim 221, wherein the product maintenance schedule includes a plurality of scheduled maintenance steps, each step including at least one recommended action.

224. A method, as set forth in claim 221, wherein the product maintenance schedule includes at least a first maintenance step and a second maintenance step, the first maintenance step includes at least one recommended action and the second maintenance step includes the at least one recommended action and at least one other recommended action.

225. A method, as set forth in claim 224, wherein the first maintenance step is scheduled at X service hours and the second maintenance step is scheduled at Y service hours, where Y>X.

226. A method, as set forth in claim 225, wherein the status information includes actual service hours.

227. A method, as set forth in claim 225, wherein the product maintenance recommendation for a specific machine is to perform the first maintenance step at X service hours if actual service hours is less than X service hours.

228. A method, as set forth in claim 227, wherein the product maintenance recommendation for the specific machine is to perform the first maintenance step if the first maintenance step has not been performed and actual service hours for the specific machine are less than (X+x), where (X+x) is less than Y.

229. A method, as set forth in claim 228, wherein the product maintenance recommendation is to perform the second maintenance step if the first maintenance step has not been performed and actual service hours for the specific machine are greater than (X+x).

230. A method, as set forth in claim 228, wherein x is equal to (Y−X)/2.

231. A method (800), as set forth in claim 221, including the step of modifying the product maintenance schedule in response to input from a user (114).

232. A method, as set forth in claim 221, wherein the product maintenance schedule includes a plurality of scheduled maintenance steps, each step including at least one recommended action, the method including the step of modifying the product maintenance schedule as a function of when a schedule maintenance step was performed.

233. A method, as set forth in claim 225, wherein the service hours at which the second scheduled maintenance step is scheduled is modified as a function of an actual service hour at which the first scheduled maintenance step was performed.

234. A method, as set forth in claim 225, wherein Y is adjusted by N hours, if the first maintenance step was performed at X+N service hours.

235. A method for managing a plurality of machines, including the steps of:
establishing status information related to the machines;
receiving and storing the status information in a repository, the repository containing historical and machine specification information; and,
analyzing the status information as a function of the historical and machine specification information and tracking at least one event for the plurality of machines, the event being related to one of location and time.

236. A method, as set forth in claim 235, including the step of defining, by a user, the at least one event related to the one of location and time.

237. A method, as set forth in claim 236, wherein the event is one of inclusive and exclusive.
